(19) United States
(12) Patent Application Publication
(10) Pub. No.: US 2025/0365751 A1
(43) Pub. Date: Nov. 27, 2025

(54) METHOD PERFORMED BY NODE, AND NODE

(71) Applicant: Samsung Electronics Co., Ltd., Gyeonggi-do (KR)

(72) Inventors: Weiwei WANG, Beijing (CN); Hong WANG, Beijing (CN); Lixiang XU, Beijing (CN)

(21) Appl. No.: 18/871,632

(22) PCT Filed: Aug. 3, 2023
(86) PCT No.: PCT/KR2023/011407

§ 371 Date: Dec. 4, 2024

(30) Foreign Application Priority Data
Aug. 3, 2022 (CN) 202210930458.1
Jun. 6, 2023 (CN) 202310667356.X

(51) Int. Cl. H04W 72/541; H04W 72/0453

(52) U.S. Cl. CPC H04W 72/541; H04W 72/0453

(57) ABSTRACT

This invention relates to a method performed by a first node in a communication system, the method comprising: transmitting, to a terminal, a first message comprising at least one of information for the terminal to report assistance information about in-device coexistence (IDC) problem associated with at least one frequency range, or information for the terminal to report assistance information about the IDC problem associated with at least one time domain; and receiving, from the terminal, the second message comprising at least one of the assistance information about the IDC problem associated with the at least one frequency range, or the assistance information about the IDC problem associated with the at least one time domain.

### TECHNICAL FIELD

The application generally relates to a field of communication, and more particularly to a method performed by a node, and the node.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

The purpose of the present disclosure is to provide an effective method and apparatus for avoiding in-device coexistence (IDC) interference.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

According to one aspect of the present disclosure, there is provided a method performed by a first node in a communication system. The method may include: transmitting a first message to a second node, wherein, the first message is used for providing the second node with assistant information related to coexistence interference of the first node. The assistant information is information for indicating an air interface and/or a sidelink related to the coexistence interference of the first node, so as to help the second node perform a configuration required to avoid the coexistence interference of the first node.

In some implementations, the method performed by the first node may further include: receiving a second message from the second node, wherein, the second message comprises information related to a configuration of a time domain and/or a frequency domain of the first node, to avoid coexistence interference of the first node.

In some implementations, the method performed by the first node may further include: transmitting a third message to the second node, wherein, the third message is used for providing updated assistant information.

In some implementations, the method performed by the first node may further include: receiving a fourth message from the second node, wherein, the fourth message is used for indicating the first node to report the assistant information related to coexistence interference.

In some implementations, in the method performed by the first node, the first message may include at least one piece of following information: first assistant information for indicating frequency domain information related to coexistence interference; second assistant information for indicating a combination of a plurality of frequency domain ranges related to coexistence interference; third assistant information for indicating time domain information related to coexistence interference; and fourth assistant information for indicating time-frequency domain information related to coexistence interference.

The first assistant information may include at least one piece of following information: first frequency domain information, indication information of a first interference system, and indication information of a first interference direction; the second assistant information may include at least one piece of following information: second frequency domain combination information, indication information of a second interference system, and indication information of a second interference direction; the third assistant information may include at least one piece of following information: third time domain information, and third usage indication information for indicating a frequency domain range used by the third time domain information; and the fourth assistant information may include at least one piece of following information: fourth time domain information, fourth usage indication information for indicating frequency domain information applicable or not applicable to be used within a time period indicated by the fourth time domain information, and fourth frequency domain usage pattern information for indicating a pattern of using various frequency bands in the frequency domain.

In some implementations, in the method performed by the first node, the first frequency domain information may include at least one piece of following information: first range information, first frequency point information, first resource information, first bandwidth part information, first cell information, first cell group information, and first usage information; the indication information of the first interference direction may indicate at least one direction of: Evolved Universal Terrestrial Radio Access (EUTRA) or its air interface, New Radio (NR) or its air interface, a Wireless Local Area Network (WLAN) module, a Bluetooth module, a positioning module, and a sidelink; the second frequency domain combination information indicates a frequency domain combination, and for a frequency band in the combination, may include at least one piece of following information: range information, frequency point information, resource information, bandwidth part information, cell information, cell group information, usage information, second state information, and second state suggestion information; the third time domain information may include at least one piece of following information: first discontinuous reception configuration information, and first time-domain pattern information; the fourth time domain information may include at least one piece of following information: period information, starting position information, and length information; and the fourth frequency domain usage mode information may include at least one piece of following information: fourth period information, information of a first frequency band sequence, information of a second frequency band sequence, and fourth length information.

In some implementations, in the method performed by the first node, the second message may include at least one piece of following information: first frequency domain configuration information, first time domain configuration information, first time-frequency domain configuration information, second transmission configuration information, and configuration indication information.

In some implementations, in the method performed by the first node, the first frequency domain configuration information may include at least one piece of following information: range information, frequency point information, resource information, bandwidth part information, cell information, and cell group information; the first time domain configuration information may include at least one piece of following information: discontinuous reception (DRX) configuration information, configuration information of a subframe pattern, and frequency band information; the first time-frequency domain configuration information may include at least one piece of following information: first time period information, and first frequency band information; the second transmission configuration information may include at least one piece of following information: number indication information, valid time information, and usage configuration information for indicating a configuration suitable for performing autonomous denial; and the configuration indication information may include at least one piece of following information: indication information of retaining a configuration, and indication information of not releasing a configuration.

In some implementations, in the method performed by the first node, the usage configuration information may include at least one piece of following information: applicable frequency domain information, applicable interface information, and applicable state information.

In some implementations, in the method performed by the first node, the third message may include at least one piece of following information: third frequency domain information, updated frequency domain information, updated frequency domain combination information, updated time domain information, and updated time-frequency domain information.

In some implementations, in the method performed by the first node, the third frequency domain information may include at least one piece of following information: range information, frequency point information, resource information, bandwidth part information, cell information, cell group information, usage information, and state information.

In some implementations, in the method performed by the first node, the fourth message may include at least one piece of following information: reporting indication information, and first transmission configuration information.

In some implementations, in the method performed by the first node, the reporting indication information may include at least one piece of following information: first reporting indication information for indicating the first node to report assistant information related to coexistence interference; second reporting indication information for indicating the first node to report assistant information related to coexistence interference regarding carrier aggregation; third reporting indication information for indicating the first node to report assistant information related to coexistence interference regarding dual connectivity; fourth reporting indication information for indicating the first node to report assistant information related to coexistence interference regarding a sidelink; fifth reporting indication information for indicating the first node to report time domain assistant information regarding coexistence interference; and sixth reporting indication information for indicating the first node to report time-frequency domain assistant information regarding coexistence interference.

In some implementations, in the method performed by the first node, the first transmission configuration information may include at least one piece of following information: number indication information, valid time information, and usage configuration information for indicating a configuration suitable for performing autonomous denial.

According to another aspect of the present disclosure, there is provided a method performed by a second node in a communication system. The method may include: receiving a first message from a first node, wherein, the first message is used for providing the second node with assistant information related to coexistence interference of the first node. The assistant information is information for indicating an air interface and/or a sidelink related to the coexistence interference of the first node, so as to help the second node perform configuration required to avoid the coexistence interference of the first node.

In some implementations, the method performed by the second node may further include: transmitting a second message to the first node, wherein, the second message comprises information related to a configuration of a time domain and/or a frequency domain of the first node, to avoid coexistence interference of the first node.

In some implementations, the method performed by the second node may further include: receiving a third message from the first node, wherein, the third message is used for providing updated assistant information.

In some implementations, the method performed by the second node may further include: transmitting a fourth message to the first node, wherein, the fourth message is used for indicating the first node to report the assistant information related to coexistence interference. According to another aspect of the present disclosure, there is provided a method performed by a first network node in a communication system. The method may include: transmitting a fifth message to a second network node, wherein, the fifth message may include assistant information related to coexistence interference of the first node and/or configuration information for avoiding coexistence interference of the first node.

In some implementations, in the method performed by the first network node, the fifth message may include at least one piece of following information: first network assistant information, first network configuration information, and first interference indication information.

In some implementations, in the method performed by the first network node, the first network assistant information may include at least one piece of following information: range information, frequency point information, resource information, bandwidth part information, cell information, cell group information, and state information; the first network configuration information may include at least one piece of following information: second frequency domain configuration information, first time domain configuration information, first time-frequency domain configuration information, and second configuration information.

In some implementations, in the method performed by the first network node, the second frequency domain configuration information may include at least one piece of following information: range information, frequency point information, resource information, bandwidth part information, cell information, cell group information, first state configuration information, first state setting information, and first state request information; the first time domain configuration information may include at least one piece of following information: time domain information, and usage indication information; and the time-frequency domain configuration information may include at least one piece of following information: time domain information, usage indication information, and frequency domain usage mode information.

According to a further aspect of the present disclosure, there is provided a method performed by a second network node in a communication system. The method may include: receiving a fifth message from the first network node, wherein, the fifth message may include assistant information related to coexistence interference of a first node and/or configuration information for avoiding coexistence interference of the first node.

In some implementations, the method performed by the second network node may further include: transmitting a second message to the first node, wherein, the second message may include information related to a configuration of a time domain and/or a frequency domain of the first node, to avoid coexistence interference of the first node.

According to yet another aspect of the present disclosure, there is provided a method performed by a first node in a communication system. The method may include: transmitting a first message to a first network node; and receiving a second message from a second network node after a fifth message is transmitted from the first network node to the second network node, wherein, the first message may include assistant information related to coexistence interference of the first node; wherein, the second message may include information related to a configuration of a time domain and/or a frequency domain of the first node, to avoid coexistence interference of the first node; and wherein, the fifth message may include assistant information related to coexistence interference of the first node and/or configuration information for avoiding coexistence interference of the first node.

According to yet another aspect of the present disclosure, there is provided a first node. The first node may include: a transceiver, for transmitting and receiving a signal; and a controller, coupled to the transceiver and configured to execute the method performed by the first node as described above.

According to yet another aspect of the present disclosure, there is provided a second node. The second node may include: a transceiver, for transmitting and receiving a signal; and a controller, coupled to the transceiver and configured to execute the method performed by the second node as described above.

According to yet another aspect of the present disclosure, there is provided a first network node. The first network node may include: a transceiver, for transmitting and receiving a signal; and a controller, coupled to the transceiver and configured to execute the method performed by the first network node as described above.

According to yet another aspect of the present disclosure, there is provided a second network node. The second network node may include: a transceiver, for transmitting and receiving a signal; and a controller, coupled to the transceiver and configured to execute the method performed by the second network node as described above.

### Advantageous Effects of Invention

The present disclosure provides an effective and efficient method for avoiding in-device coexistence (IDC) interference. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

FIG. 1 is an exemplary system architecture of system architecture evolution (SAE).

FIG. 2 is an exemplary system architecture according to various embodiments of the present disclosure.

FIG. 3 is an example of coexistence interference that may exist in a user equipment.

FIG. 4 is a first example process according to an exemplary embodiment of the present disclosure.

FIG. 5 is a second example process according to an exemplary embodiment of the present disclosure.

FIG. 5a is a schematic diagram of model training.

FIG. 5b is a schematic diagram of model deployment.

FIG. 5c is a schematic diagram of a process of model deployment and inference.

FIG. 5d is a first schematic diagram of model updating.

FIG. 5e is a second schematic diagram of model updating.

FIG. 5f is a schematic diagram of operations of a Uu link and a PC link in a sidelink relay technology.

FIG. 6 is a block diagram of a node according to an exemplary embodiment of the present disclosure.

FIG. 7 is a block diagram of a user equipment according to an exemplary embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

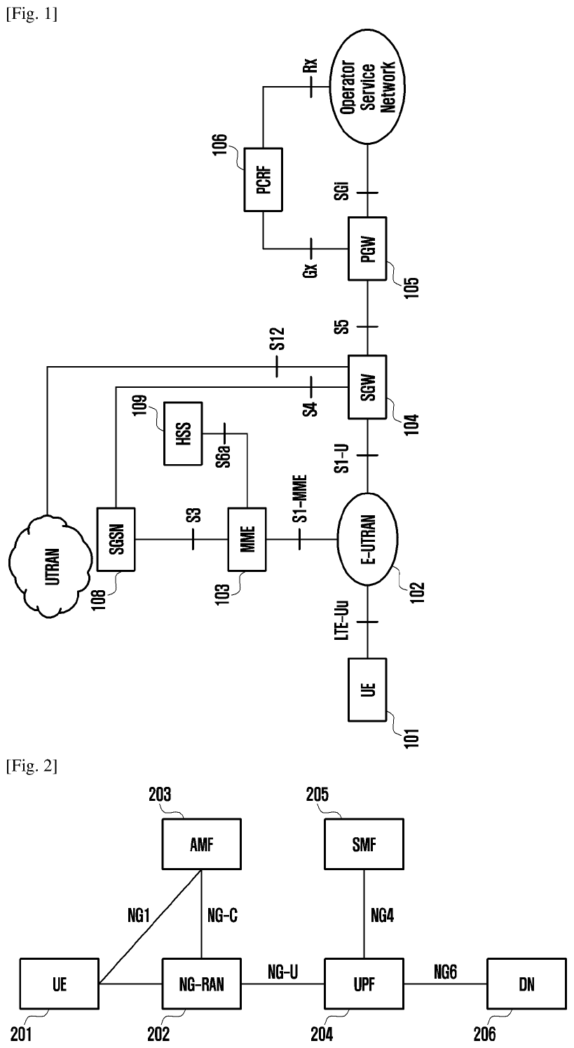

FIGS. 1 to 7 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

In a New Radio (NR) access network, in addition to a module which accesses the NR network, a user terminal device may also include other modules (such as a wireless local area network module, a Bluetooth module, and a positioning module (such as a Global Positioning System (GPS) module, a Global Navigation Satellite System (GNSS) module, etc.)) for wireless communication. Such configuration of multiple wireless communication modules can help a user terminal to access a wireless network in various ways, and can also enable the user terminal to be connected with various different peripheral devices, so that experience when a user enjoys different types of services is greatly improved.

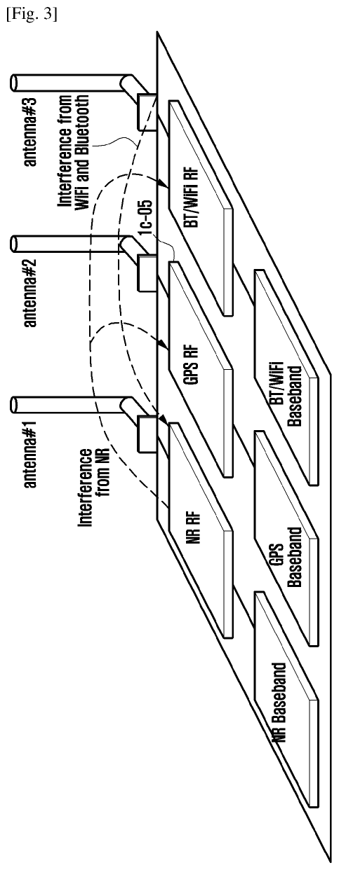

In order to improve user experience, generally, various different wireless modules (such as a NR (5G) module for accessing the NR network, a LTE module for accessing a LTE network, a WIFI module for accessing a wireless local area network, a Bluetooth (BT) module for accessing Bluetooth, and a positioning module (such as the GPS, the GNSS, etc.) for receiving a positioning signal) may be configured on the user terminal device. The working frequencies of these modules may be relatively ap-proximate, which can result in interferences among the modules. As shown in FIG. 3, interferences among the modules include, for example, but are not limited to, an interference of the NR module to the WIFI and/or Bluetooth module, an interference of the WIFI and/or Bluetooth module to the NR module, and an interference of the NR module to the GPS positioning module. Such interferences can reduce the rate of the user equipment for receiving data, and even result in interruption of the wireless connection of the user equipment. In order to solve the problem of interferences among the modules in the user terminal device, 3GPP Rel-18 starts a new research subject, i.e., in-device coexistence interference avoidance. This is a technical problem that the present disclosure wants to solve, i.e., the technical problem how to reduce or avoid interferences when there are interferences among different wireless modules on the user terminal device. In the present disclosure, the in-device coexistence interference may also be referred to as coexistence interference for short.

Before specific contents are introduced, some assumptions and some definitions of the present disclosure are given below.
Message names in the present disclosure are merely examples, and other message names may also be used.
Words such as “first” and “second” and so on included in the message names in the present disclosure are merely used for distinguishing one message from another message, but do not denote the execution order.
In the present disclosure, detailed description of steps unrelated to the present disclosure is omitted.
In the present disclosure, steps in various processes may be combined with each other for execution, or may be executed separately. The execution steps of various processes are merely exemplary, other possible execution steps and/or orders are not excluded.
In the present disclosure, a base station may be a 5G base station (such as a gNB, an ng-eNB), or may be a 4G base station (such as an eNB), or may be other types of access nodes.
In the present disclosure, the in-device coexistence interference problem may be a signal interference, or may be an inter-modulation distortion and harmonics.
In the present disclosure, the frequency domain range, the frequency band, and the frequency range have the same meaning, i.e., indicate resources of a section of frequency domain.
In the present disclosure, a sidelink may also be referred to as a bypass.

Nodes involved in the present disclosure include:
A first node, which is a user terminal device, wherein different wireless communication modules, such as the NR module, the WIFI module, the Bluetooth module, and the positioning module, etc., may be included on the device.
A second node, which is a base station, or a central unit of the base station, or a control plane portion of the central unit of the base station, or a distributed unit of the base station. The second node is a node connected with the first node, i.e., the first node performs data communication with the second node.
A third node, which is a base station, or a central unit of the base station, or a control plane portion of the central unit of the base station, or a distributed unit of the base station. The third node is a node different from the second node. The third node may be a node connected with the first node.
A fourth node, which is a central unit of a base station, or a control plane portion of the central unit of the base station, wherein when the second node and the third node respectively are two distributed units connected with the first node, the fourth node is the central unit or the control plane portion of the central unit connected with the second node and the third node.

In one embodiment, when the first node is in dual connectivity (such as Evolved Universal Mobile Telecommunications System (UMTS) Terrestrial Radio Access Network (E-UTRAN) New Radio-Dual Connectivity (EN-DC), Multi-RAT-Dual Connectivity (MR-DC), and NR-NR DC), the second node and the third node are two different base stations (or central units of the base stations, or control plane portions of the central units of the base stations) connected with the first node, which are a master node (a master base station) and a secondary node (a secondary base station) respectively, or are a secondary node (a secondary base station) and a master node (a master base station) respectively. In one embodiment, when the first node is in dual-connectivity (such as EN-DC, MR-DC, and NR-NR DC) state, the second node and the third node are two different distributed units connected with the first node. In another embodiment, the second node and the third node are a last serving node (such as a last serving base station, or a last/old serving BS/eNB/gNB) and a new serving node (such as a new serving base station, a new serving BS/eNB/gNB) connected with the first node, and specifically, when the first node is in an inactive state, the second node is a node connected with the first node before the first node enters the inactive state, and the third node is a node where the first node is located when initiating a resume request in the inactive state.

### First Aspect: Provision of Assistant Information

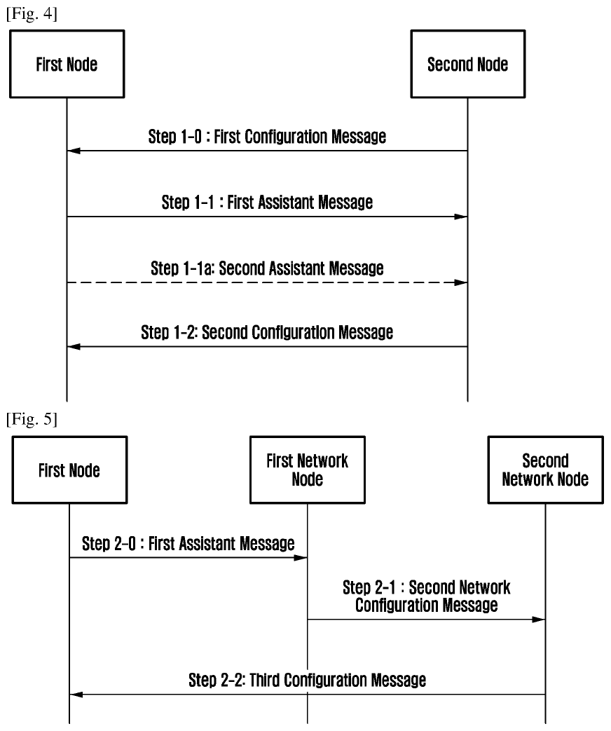

In-device coexistence interferences occur in a user terminal device, so only the terminal device can discover such interferences. In order to solve the problem of such interferences, a base station that serves the terminal device needs to get involved. In order to enable the base station to accurately acquire an interference situation in the terminal device, it is a relatively effective technical means that the terminal device provides assistant information to the base station. The present disclosure is to solve the technical problem of design of the assistant information provided by the terminal device so as to help the base station to discover coexistence interference at the terminal device and avoid such interference in a proper way. In order to solve this problem, the present disclosure proposes a method for providing assistant information related to coexistence interference to a base station by a terminal device. The method may include the following process, as shown in FIG. 4:

Step 1-1: a first node transmits a first message to a second node (or a fourth node), and the first message may be a first assistant message. The function of this message is to provide assistant information related to coexistence interference to the second node. When the second node (or the fourth node) is a central unit of a base station or a control plane portion of the central unit of the base station, the second node (or the fourth node) may also transmit the first message to a distributed unit of the base station, and then a configuration for avoiding coexistence interference is generated by the distributed unit. The message may include at least one piece of the following information:
First assistant information that provides frequency domain information related to a coexistence interference, such as information of a frequency domain influenced by the coexistence interference. Each frequency domain range indicated by the information (possibly) can cause a coexistence interference. In one embodiment, a frequency band indicated by the frequency domain information is a frequency band used by an air interface between the first node and the second node, and in another embodiment, the frequency band indicated by the frequency domain information is a frequency band used by a sidelink between the first node and another node. After receiving the information, the second node can configure a frequency domain range used by a user equipment, and this frequency domain range can avoid appearance of the coexistence interference problem. The information has the beneficial effect that: information of one frequency band in which coexistence interferences (might) exist can be obtained by the network side so as to help the network side to select a proper frequency band to perform data transmission with the first node. For one frequency domain range, the information may include at least one piece of the following information:
First frequency domain information, which indicates a frequency domain range in which a coexistence interference problem already exists or possibly exist. The frequency domain range may be a range of a frequency domain used by one wireless module (such as an NR module) on a terminal device. In one embodiment, the range is a range of a frequency domain in which one wireless module (such as the NR module) (possibly) causes the coexistence interference problem to other modules. In another embodiment, the range is a range of a frequency domain in which other modules (possibly) cause the coexistence interference problem to one wireless module (such as the NR module). In yet another embodiment, the range is both the range of the frequency domain in which one wireless module (such as the NR module) (possibly) causes the coexistence interference problem to other modules and the range of the frequency domain in which other modules (possibly) cause the coexistence interference problem to one wireless module (such as the NR module). The information may include at least one piece of the following information:
First range information, which indicates a frequency domain range, and furthermore, this information may include at least one piece of the following information:
First starting point information, which indicates a starting point position of the frequency domain range. In one embodiment, the information indicates offset information of a starting point of the frequency domain range relative to a reference point; in another embodiment, the information indicates a sequence number of a Physical Resource Block (PRB); in yet another embodiment, the information indicates a sequence number of a sub-carrier; in still a further embodiment, the information indicates a sequence number of a sub-band; and in one additional embodiment, the information indicates a sequence number of a channel
First bandwidth information, which indicates a bandwidth of the frequency domain range, may include at least one piece of the following information:
A value size of the bandwidth, such as 10 MHz, 5.5 MHz, etc.;
A number of PRBs;
A number of sub-carriers;
A number of sub-bands;
A number of channels; and
Bandwidth percentage information, which indicates a percentage of the “bandwidth of the frequency domain range” to one total bandwidth (such as a bandwidth of one cell, a bandwidth of one Bandwidth Part (BWP), a bandwidth of one channel, and a bandwidth of one sub-band), may include at least one piece of the following information:
A bandwidth percentage
Indication information of a total bandwidth, such as the bandwidth of the cell, the bandwidth of the BWP, the bandwidth of the channel, the bandwidth of the sub-band, and a bandwidth of a chunk, which may further indicate identification information of the total bandwidth, such as an identification of the cell, an identification of the BWP, an identification of the channel, an identification of the sub-band, an identification of the chunk, etc.
Position information that indicates position information of the “bandwidth of the frequency domain range” in the “total bandwidth” (for example, the “bandwidth of the frequency domain range” is located at a low-frequency-band part of the “total bandwidth”, or located at a middle-frequency-band part of the “total bandwidth”, or located at a high-frequency-band part of the “total bandwidth”, etc.)
First configuration information, which indicates configuration information of a frequency domain, such as information (e.g., 15 KHz, 30 KHz, 60 KHz, 90 KHz, 120 KHz, etc.) of a sub-carrier interval, and that indicates an interval of a sub-carrier at which the above first starting point information and/or the first bandwidth information aims. In an example, the information may be reference configuration information, i.e., the above first starting point information and/or the first bandwidth information is defined with reference to the “first configuration information”
First frequency point information, which indicates a position of a carrier frequency point. In one embodiment, the information gives a specific frequency point position; in another embodiment, the information gives measurement information corresponding to the carrier frequency point (such as measurement identification information measID, and identification information measobjectID of a measurement object that indicates a measured frequency point); in yet another embodiment, the information indicates index information of the frequency point, such as a Frequency Range 1 (FR1)/FR2 index; and further, the information may also include a configuration (such as the sub-carrier interval) of a sub-carrier at which the frequency point aims.
First resource information, which indicates a resource of a sidelink. In one embodiment, the information indicates identification information of a resource pool of a sidelink used by the first node; and in another embodiment, the information indicates a measurement object when the first node measures the sidelink, the measurement object includes resource pools of one or more sidelinks, and each resource pool is indicated by the identification information of the resource pool
First BandWidth Part information, which indicates one or more BWPs. The BWP may be a BWP (Uu BWP) used by the air interface between the first node and the second node, or may be a BWP (Sidelink BWP) used on a sidelink between the first node and another node. In one embodiment, the information may be identification information of the BWP; in another embodiment, the information may be position and bandwidth information of the BWP; in yet another embodiment, the information may be indication information of an initial BWP, which indicates the initial BWP used by the user equipment; in still a further embodiment, the information may be indication information of a default BWP, which indicates the default BWP used by the user equipment; and further, the information may also include information of a frequency point where the BWP is located (or identification information of a measurement object corresponding to the frequency point, or identification information of a measurement corresponding to the frequency point), and/or identification information of a cell, and/or information of a sub-carrier interval
First cell information, which indicates identification information of one cell, such as a cell index (a serving cell index), a Physical Cell Identifier (PCI), an NR Cell Global Identity (CGI), etc.
First cell group information, which indicates identification information of one cell group and may also be used for indicating the cell group, such as a Master Cell Group (MCG), a Secondary Cell Group (SCG), etc.
First usage information, which indicates a usage of the frequency band indicated by the above “first frequency domain information”, such as a usage for data transmission of a LTE network, a usage for data transmission of an NR network, a usage for data transmission of the sidelink, etc.
Indication information of a first interference system, which indicates a system influenced by the coexistence interference problem, i.e., the performance of the system is reduced due to the coexistence interference problem. The system indicated by the information may include at least one of the following systems: a Global Positioning System (GPS), a Global Navigation Satellite System (GLONASS), a BeiDou Satellite Navigation System (BDS), a GALILEO positioning system, a Wireless Local Area Network (WLAN), BLUETOOTH, an Indian regional navigation satellite system (NAVIC), a sidelink, etc.
Indication information of a first interference direction, which indicates a direction of a coexistence interference, i.e., a direction that (possibly) has the coexistence interference problem. The information may indicate at least one of the following directions:
An EUTRA or an air interface of the EUTRA;
An NR or an air interface of the NR;
Others, such as a module (e.g., the WLAN, the Bluetooth) that adopts an unau-thorized frequency band, a positioning system, etc;
A sidelink.

Further, the above indication information of the first interference direction may be any combination of two or more of the directions above, e.g., but not limited to, a combination of the EUTRA and the NR, a combination of the NR and others, a combination of the EUTRA and others, a combination of (the air interface of) the EUTRA and the sidelink, a combination of (the air interface of) the NR and the sidelink, a combination of the sidelink and others, a combination of the EUTRA, the NR, and others, a combination of the EUTRA, the NR, and the sidelink, a combination of the sidelink, the NR, and others, a combination of the EUTRA, the sidelink, and others, a combination of the EUTRA, the NR, others, and the sidelink, etc.
Second assistant information, which indicates a combination of a plurality of frequency domain ranges, which already has the coexistence interference problem or possibly has the coexistence interference problem. The combination includes a plurality of frequency domain ranges. The information is different from the “first assistant information”. The frequency domain range indicated by the “first assistant information” is one frequency domain range in which one module on the terminal device (possibly) has the coexistence interference problem. The combination of a plurality of frequency domain ranges indicated by the “second assistant information” is that when one module of the terminal device simultaneously works in all the frequency domain ranges in the combination, the coexistence interference problem (possibly) can be generated. For example, if there are two frequency domain ranges, i.e., a frequency domain range 1 and a frequency domain range 2, the “first assistant information” will indicate that when the NR module works in the frequency domain range 1, the coexistence interference problem (possibly) might exist, while the “second assistant information” will indicate that when the NR module simultaneously works in the frequency domain range 1 and the frequency domain range 2, the coexistence interference problem (possibly) will exist, and if the NR module only works in the frequency domain range 1, there will be no coexistence interference problem. In one embodiment, the frequency domain ranges indicated by the information are frequency domain ranges when the first node works in a carrier aggregation mode; in another embodiment, the frequency domain ranges indicated by the information are frequency domain ranges when the first node works in a dual connectivity mode and these frequency domain ranges are frequency domain ranges served by different base stations (or distributed units of different base stations) in the dual connectivity; in yet another embodiment, the frequency domain ranges indicated by the information not only include frequency domain ranges on different carriers in the carrier aggregation, but also include different frequency domain ranges served by different base stations (or distributed units of different base stations) in the dual connectivity; in still a further embodiment, the frequency domain ranges indicated by the information are frequency domain ranges represented by different BWPs; and in one additional embodiment, the frequency domain ranges indicated by the information may be a combination of various different frequency domain ranges. After receiving the information, the second node can adjust the frequency domain range used by the user equipment or coordinate with other network nodes (e.g., interact the “second assistant information”) so as to avoid simultaneous usage of the plurality of frequency domain ranges indicated in the information. The information has the beneficial effect that: the combination of a plurality of frequency bands which (possibly) have coexistence interference can be obtained by the network side so as to help the network side to avoid simultaneous usage of the plurality of frequency bands to serve the first node, thereby avoiding coexistence interference of the first node. For one combination of the frequency domain ranges, the information may include at least one piece of the following information:
Second frequency domain combination information, which indicates a combination of different frequency domain ranges, i.e., indicates a plurality of different frequency domain ranges. In one embodiment, a frequency band indicated by the frequency domain information may be a frequency band used by the air interface between the first node and the second node; and in another embodiment, the frequency band indicated by the frequency domain information is a frequency band used on the sidelink between the first node and another node. For any one frequency domain range in the combination, the information may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BandWidth Part information, for the specific description thereof, please refer to the “first BandWidth Part information”
Cell information, for the specific description thereof, please refer to the “first cell information”
Cell group information, for the specific description thereof, please refer to the “first cell group information”
Usage information, for the specific description thereof, please refer to the “first usage information”
Second state information, which indicates a current state (such as an active state or an inactive state) of the frequency domain ranges indicated by the “range information”, and/or the “frequency point information”, and/or “the resource information”, and/or the “BWP information”, and/or the “cell information”, and/or the “cell group information” included in the “second frequency domain combination information”. Further, the “active” (or “inactive) state indicates that parts of the frequency domain ranges indicated by the “range information”, and/or the “frequency point information”, and/or “the resource information”, and/or the “BWP information”, and/or the “cell information”, and/or the “cell group information” are in the active (or “inactive) state. The information has the beneficial effect that in a case that the first node is in a dual-connectivity or multi-connectivity, the second node (a master base station or a secondary base station connected with the first node, or a central unit or a control plane portion of the central unit to which the distributed unit connected with the first node belongs) can know states of the frequency domain ranges indicated by the information of other nodes (nodes different from the second node, or one of a plurality of distributed units of the second node connected with the first node when the first node is connected to the plurality of distributed units) connected with the first node so as to avoid a case that a plurality of frequency bands that serve the first node are simultaneously activated to cause coexistence interference. Further, in order to indicate the state of the frequency domain range, the information may also indicate a time point (the time point indicates a starting time position where the frequency domain range is activated or deactivated) and/or a time length when the frequency domain range is to be activated or deactivated
Second state suggestion information, which indicates the states (which is suggested by the first node) of the frequency domain ranges (such as a corresponding frequency domain range is suggested to be activated or deactivated) indicated by the “range information”, and/or the “frequency point information”, and/or “the resource information”, and/or the “BWP information”, and/or the “cell information”, and/or the “cell group information” included in the “second frequency domain combination information”. The information has the beneficial effects of helping the second node to configure the state of each frequency band so as to avoid the coexistence interference problem caused by synchronous usage of a plurality of frequency bands, and further, the information may also indicate a time point and/or a time length when it is suggested to start to activate or deactivate a frequency domain range

In a specific implementation, different frequency domain ranges in the second frequency domain combination information can be indicated by different information in the information above. Example 1: the frequency domain range 1 is indicated by the frequency point information, the frequency domain range 2 is indicated by the starting point information and the bandwidth information, and a frequency domain range 3 is indicated by the BWP information; Example 2: the frequency domain range 1 is indicated by the BWP information, and the frequency domain range 2 is also indicated by the BWP information; and Example 3: the frequency domain range 1 is indicated by the frequency point information, and the frequency domain range 2 is indicated by the BWP information. The above are merely examples, and the frequency domain ranges in the combination can be indicated by any of the information above without departure from the concept of the present disclosure. Specifically, for one user equipment in the dual connectivity, a plurality of frequency domain ranges that can be reported by the user equipment include a carrier frequency of the LTE (E-UTRAN)/NR (or an identification of the measurement object, or an identification of a measurement), a carrier frequency of the NR (or a cell identification, or an identification of a measurement object, or an identification of a measurement), and an identification of a BWP.
Indication information of a second interference system, which indicates a system influenced by the coexistence interference problem. In one embodiment, the “influence by the coexistence interference problem” refers to reduction of the performance due to the coexistence interference problem caused by the combination of a plurality of frequency domain ranges indicated by the “second frequency domain combination information”. The system indicated by the information can refer to the description on the “indication information of the first interference system”
Indication information of a second interference direction, which indicates a direction of coexistence interference. In one embodiment, the direction of coexistence interference refers to a direction of the coexistence interference problem caused by the combination of a plurality of frequency domain ranges indicated by the “second frequency domain combination information”. The specific contents of the information can refer to the description on the “indication information of the first interference direction”
Third assistant information, which provides time-domain information related to coexistence interference. In one embodiment, the time-domain information may aim at the air interface between the first node and the second node. In another embodiment, the time-domain information may aim at a sidelink between the first node and another node. After receiving the information, the second node can perform time-domain configuration of data transmission for the user equipment (for example, configuring a time range used by the user equipment for data transmission, configuring a frequency domain range used by the user equipment for data transmission, and the like). The information has the beneficial effect that the network side can select a proper time period according to third assistant information to serve the first node so as to avoid a data transmission failure of the first node on the configured frequency band, which is caused by the coexistence interference problem. The information may include at least one piece of the following information:
Third time-domain information, which indicates configuration information of a time domain expected by the first node and may include at least one piece of the following information:
Configuration information of first discontinuous reception, which may include at least one piece of the following information: cycle length information, offset information, and active time length information. Further, the information may also include information of an applicable interface, and for example, the applicable interface is an air interface (a Uu interface, i.e., an interface between the first node and the base station) or a PC5 interface (an interface of a sidelink, i.e., an interface of the sidelink established by the first node and another node)
First time-domain pattern information, which indicates a pattern of a time-domain configuration expected by the first node, i.e., time-domain position information for the first node to perform uplink transmission and time-domain position information for the first node to perform downlink transmission. Specifically, the information may include at least one piece of the following information:
Second period information, which indicates a period of the pattern of the time-domain configuration
Number information of downlink time slots
Number information of downlink symbols
Number information of uplink time slots
Number information of uplink symbols
Third usage indication information, which indicates a frequency domain range to which the “third time-domain information” is applicable. The information may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”
Cell information, for the specific description thereof, please refer to the “first cell information”
Cell group information, for the specific description thereof, please refer to the “first cell group information”
Fourth assistant information, which provides time-frequency domain information related to coexistence interference and indicates information of a frequency band expected to use by the first node in a time period. In one embodiment, the time-frequency domain information may aim at the air interface between the first node and the second node. In another embodiment, the time-frequency domain information may aim at a sidelink between the first node and another node. Specifically, the coexistence interference problem of the first node to which the information is applicable is caused by simultaneous usage of different frequency bands in different cell groups. After receiving the information, the second node can perform a time-frequency domain configuration of data transmission for the user equipment (for example, configuring a time range and a frequency domain range for data transmission of the user equipment). The information has the beneficial effect of helping the network side to select different frequency bands in different time periods to serve the first node so as to avoid the data transmission failure of the first node occurs on the configured frequency band, which is caused by the coexistence interference problem. The information may include at least one piece of the following information:
Fourth time-domain information, which indicates one time period on a time domain. In one embodiment, the time period may be active time or inactive time after the first node configures DRX. In another embodiment, the time period may be an uplink or downlink time period indicated by the “first time-domain pattern information”. In yet another embodiment, the time period may be a newly defined time period. The information may include at least one piece of the following information:
Period information, which indicates a period of appearance of the “one time period on the time domain”
Starting position information, such as an identification of a starting time slot, an identification of a starting symbol, a starting frame number, etc.
Length information, which indicates length information of the “one time period on the time domain”, such as a number of time slots, and/or a number of symbols, and/or a number of frames, etc
Fourth usage indication information, which indicates frequency domain information applicable (or inapplicable) to be used in the time period indicated by the “fourth time-domain information”. Namely, a frequency band in a frequency domain indicated by the information may (or may not) be used in the time period indicated by the “fourth time-domain information”. There may be one or more frequency domain ranges indicated by the information. For one frequency domain range applicable to use in the time period indicated by the “fourth time-domain information”, the information may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”
Cell information, for the specific description thereof, please refer to the “first cell information”
Cell group information, for the specific description thereof, please refer to the “first cell group information”
For one frequency domain range inapplicable to use in the time period indicated by the “fourth time-domain information”, the information may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”
Cell information, for the specific description thereof, please refer to the “first cell information”
Cell group information, for the specific description thereof, please refer to the “first cell group information”
Fourth frequency domain usage pattern information that indicates one pattern for using each frequency band in the frequency domain. In order to represent the pattern, the information may include at least one piece of the following information:
Fourth period information that indicates a period of the “one pattern”
Information of a first frequency band sequence, which indicates an order of each used frequency band, such as a frequency band 1, a frequency band 2, a frequency band 3, etc., i.e., frequency bands 1/2/3 and the like are sequentially used. Each frequency band may be a frequency band indicated by one or more of the “first range information”, and/or the “first frequency point information”, and/or the “first resource information”, and/or the “first BandWidth Part information”, and/or the “first cell information”, and/or the “first cell group information”. Further, information of a time length during which each frequency band is used (such as a number of subframes, and/or a number of the time slots, and/or a number of the symbols, etc.) may also be indicated
Information of a second frequency band sequence, which indicates an order of each unused frequency band, such as a frequency band 1, a frequency band 2, a frequency band 3, etc., i.e., frequency bands 1/2/3 and the like sequentially may not be used. Each frequency band may be a frequency band indicated by one or more of the “first range information”, and/or the “first frequency point information”, and/or the “first resource information”, and/or the “first BandWidth Part information”, and/or the “first cell information”, and/or the “first cell group information”. Further, information of a time length during which each frequency band is not used (such as a number of the subframes, and/or a number of the time slots, and/or a number of the symbols, etc.) may also be indicated
Fourth length information that indicates length information of usage of one frequency band, such as a number of the subframes, and/or a number of the time slots, and/or a number of the symbols, etc
Step 1-2: the second (or the fourth node) configures the first node to perform coexistence interference avoidance. The second node will perform configuration of the time domain and/or the frequency domain of the first node according to the assistant information transmitted by the first node in the Step 1-1 so as to avoid occurrence of coexistence interference. The second node (or the fourth node) transmits a second message to the first node, and the second message may be a second configuration message. The second configuration message may be generated according to the first assistant message transmitted by the first node in the Step 1-1. After receiving the message, the first node will perform data transmission on configured time-frequency domain resources according to configuration information included in the message. When the second node (or the fourth node) is a central unit of a base station or a control plane portion of the central unit of the base station, part or all of the configuration information in the second message may be generated by a distributed unit of the base station, then transmitted to the second node (or the fourth node), and transmitted to the first node by the second node (the fourth node). The information which is included by the message and is related to the configuration of the time domain and/or the frequency domain may include at least one piece of the following information:
First frequency domain configuration information, which is configuration information for avoiding coexistence interference on the frequency domain according to the information provided in the Step 1-1. In one embodiment, the information is configured according to the “first assistant information”. In another embodiment, the information is configured according to the “second assistant information”. The information indicates a frequency band used by the first node. The information takes the effect of configuring the frequency band used by the first node, and this frequency band can avoid coexistence interference at the first node. In one embodiment, the configuration is implemented by way of cell switching. In another embodiment, the configuration is implemented by way of BWP switching. In yet another implementation, the configuration is implemented by way of cell activation or deactivation. The information has the beneficial effect that the network side can configure a proper frequency band to serve the first band so as to avoid the data transmission failure of the first node occurs on the configured frequency band, which is caused by the coexistence interference problem. The frequency band may be represented by at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”;
Cell information, for the specific description thereof, please refer to the “first cell information”
Cell group information, for the specific description thereof, please refer to the “first cell group information”
First time domain configuration information, which is configuration information for avoiding coexistence interference on the time domain according to the information provided in the Step 1-1. In one embodiment, the information is configured according to the “third assistant information”. The information takes the effect of configuring a time period during which the first node uses a frequency band, and the first node can use the frequency band with coexistence interference in the time period. The information has the beneficial effect that the network side can adopt different time-domain configurations for different frequency bands so as to avoid simultaneous usage of a plurality of frequency bands causing coexistence interference, thereby avoiding the data transmission failure of the first node occurs on the configured frequency band, which is caused by the coexistence interference problem. The information may include at least one piece of the following information:
DRX configuration information
Configuration information of a subframe pattern, which indicates a subframe number of downlink (and/or uplink) subframes and/or a number of time slots and/or a number of symbols
Frequency band information, which indicates frequency band information to which the “DRX configuration information” and/or “configuration information of a subframe pattern” are applicable. The information may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”
Cell information, for the specific description thereof, please refer to the “first cell information”
Cell group information, for the specific description thereof, please refer to the “first cell group information”
First time-frequency domain configuration information, which is configuration information for avoiding coexistence interference on the time-frequency domain according to the information provided in the Step 1-1. In one embodiment, the information is configured according to the “fourth assistant information”. The information takes the effect of configuring the first node to use different frequency bands in different time periods so as to avoid coexistence interference. The information has the beneficial effect that the network side can configure the first node to use different frequency bands in different time periods to perform data transmission so as to avoid simultaneous usage of a plurality of frequency bands causing coexistence interference. The information may include at least one piece of the following information:
First time period information that indicates one time period, such as a starting point of the time period and/or a length of the time period
First frequency band information that indicates one used frequency band and may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part Information”
Cell information, for the specific description thereof, please refer to the “first cell information”
Cell group information, for the specific description thereof, please refer to the “first cell group information”
Second transmission configuration information, which indicates configuration information required by data transmission performed when the first node carries out coexistence interference avoidance. In one embodiment, the information indicates configuration information required when the first node performs an autonomous denial operation, and the autonomous denial refers to a case that the first node can refuse uplink and/or downlink scheduling thereof by the base station. The information has the beneficial effect that the first node can autonomously refuse scheduling by the network side according to the information so as to avoid coexistence interference to other modules on the device. The information may include at least one piece of the following information:
Number indication information that indicates a number of time periods which the first node can refuse. The time periods may be subframes, time slots, symbols, etc. The information may also indicate a number of scheduling (uplink and/or downlink scheduling) which the first node can refuse
Valid time information, which indicates information of a time length during which the first node can perform autonomous denial, i.e., the first node can perform autonomous denial in a time period indicated by the time length
Usage configuration information, which indicates a configuration applicable to perform autonomous denial and may include at least one piece of the following information:
Applicable frequency domain information, which indicates frequency domain information applicable to autonomous denial. Namely, a frequency band in a frequency domain indicated by the information can be autonomously refused in the time period indicated by the “valid time information”. There may be one or more frequency domain ranges indicated by the information. For one frequency domain range, the information may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part Information”
Cell information, for the specific description thereof, please refer to the “first cell information”
Cell group information, for the specific description thereof, please refer to the “first cell group information”
Applicable interface information, which indicates information of an interface applicable to autonomous denial, such as the air interface between the first node and the second node, a sidelink interface between the first node and another node, etc.
Applicable state information, which indicates state information of the first node (i.e., the user equipment) applicable to autonomous denial, such as indication information that the first node is in a connected state, indication information that the first node is in the inactive state, and indication information that the first node is in a small data transmission state
Configuration indication information, which takes the effect for indicating the first node to retain and/or not to release the configuration for avoiding coexistence interference. The information has the beneficial effects that after entering the inactive state, the first node still can retain the related configuration for avoiding coexistence interference, and when the first node performs data transmission, the data transmission failure caused by coexistence interference is avoided. The information may include at least one piece of the following information:
Indication information of retaining a configuration. The information indicates a configuration which needs to be retained by the first node. The configuration may be at least one of the “first frequency domain configuration information”, and/or the “first time domain configuration information”, and/or the “first time-frequency domain configuration information”, and/or the “second transmission configuration information”. In one embodiment, when the “second configuration message” is to release the user equipment to the inactive state, the information can indicate the user equipment to retain the configuration for avoiding coexistence interference and further, can help the user equipment to avoid coexistence interference in the inactive state by utilizing these configurations
Indication information of not releasing a configuration. The information indicates a configuration which does not need to be released by the first node. The configuration which does not need to be released may be a configuration for indicating the first node to provide assistant information related to coexistence interference, such as information included in the following “first configuration message”. In one embodiment, when the “second configuration message” is to release the user equipment to the inactive state, the information may indicate that the user equipment still can report the assistant information related to coexistence interference in the inactive state

Further, optionally, between Step 1-1 and Step 1-2, the exemplary flow may further include:

Step 1-1a: the first node transmits a third message to the second node (or a third node or the fourth node). The third message may be a second assistant message which takes the effect of providing updated assistant information to the second node (or the third node or the fourth node). In one embodiment, the assistant information aims at information updated relatively fast. The information updated relatively fast, for example, is active and inactive states of the cell, active or inactive state of the BWP, etc. Specifically, the message may include at least one piece of the following information:
Third frequency domain information, which indicates one or more frequency bands used by the first node. In one embodiment, the information includes information of all the frequency bands used by the first node. In another embodiment, the information includes a frequency band which is used by the first node and served by the second node. In yet another embodiment, the information includes a frequency band which is used by the first node and served by the third node. For one frequency band, the information may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”
Cell information, for the specific description thereof, please refer to the “first cell information”
Cell group information, for the specific description thereof, please refer to the “first cell group information”
Usage information, for the specific description thereof, please refer to the “first usage information”
State information, which indicates a current state (such as the active state or the inactive state) of the frequency domain ranges indicated by the “range information”, and/or the “frequency point information”, and/or “the resource information”, and/or the “BWP information”, and/or the “cell information”, and/or the “cell group information” included in the “third frequency domain information”. The information has the beneficial effect that in the case that the first node is in the dual-connectivity or multi-connectivity, the second node (the master base station or the secondary base station connected with the first node, or the central unit or the control plane portion of the central unit to which the distributed unit connected with the first node belongs) can know states of the frequency domain ranges indicated by the information of other nodes (nodes different from the second node, or one of a plurality of distributed units of the second node connected with the first node when the first node is connected to a plurality of distributed units) connected with the first node so as to avoid the case that a plurality of frequency bands that serve the first node are simultaneously activated to cause coexistence interference
Fifth assistant information, which provides updated frequency domain information related to coexistence interference, such as information of a frequency domain influenced by coexistence interference. The description of the specific contents can refer to the “first assistant information”;
Sixth assistant information, which indicates information of a combination of a plurality of updated frequency domain ranges, which already has the coexistence interference problem or possibly has the coexistence interference problem. The combination is an updated frequency domain combination and includes a plurality of frequency domain ranges. The description of the specific contents can refer to the “second assistant information”;
Seventh assistant information, which provides updated time-domain information related to coexistence interference. The description of the specific contents can refer to the “third assistant information”;
Eighth assistant information, which provides updated time-frequency domain information related to coexistence interference. The description of the specific contents can refer to the “fourth assistant information”

The flow above has the technical effect that the second node can complete configuration on the time-domain and/or frequency domain resources of the first node according to the assistant information provided by the first node so as to avoid coexistence interference at the first node.

Optionally, before Step 1-1, the exemplary flow may further include configuration flow for providing assistant information related to coexistence interference, i.e.,

Step 1-0: the second node (or the fourth node) transmits a fourth message to the first node. The fourth message may be a first configuration message. The message takes the effect of indicating the first node to report the assistant information related to coexistence interference. The message has he beneficial effect of controlling the first node to report the assistant information related to coexistence interference so as to reduce unnecessary signaling overheads. Optionally, the first node may transmit the first assistant message to the second node in the Step 1-1 and/or transmit the second assistant message to the second node in the Step 1-1a according to the first configuration message received in the Step 1-0. The first configuration message may include at least one piece of the following information:
Reporting indication information, which indicates assistant information which needs to be reported by the first node and is related to coexistence interference. The information may include at least one piece of the following information:
First reporting indication information, which indicates the first node to report the assistant information related to coexistence interference. In one embodiment, the information indicates the first node to report the “first assistant information” in the Step 1-1. Further, the information may also include frequency band information which needs to be considered when the information related to coexistence interference is reported. The specific contents of the “frequency band information” can refer to at least one of the “first range information”, and/or the “first frequency point information”, and/or the “first resource information”, and/or the “first BandWidth Part information”, and/or the “first cell information”, and/or the “first cell group information”. In one example, the first reporting indication information may be used to indicate the first node to report the “first range information” and/or the “first BandWidth Part information” for the “first frequency point information”, and/or the “first resource information”, and/or the “first cell information”, and/or the “first cell group information”, which can limit the first node to report the “first range information” and/or the “first BandWidth Part information” in the “first assistant information” only for a designated frequency point.
Second reporting indication information, which indicates the first node to report assistant information related to coexistence interference regarding carrier aggregation. In one embodiment, the information indicates the first node to report the “second assistant information” in the Step 1-1. Further, the information may also include frequency band information which needs to be considered when the information related to coexistence interference is reported. The specific contents of the “frequency band information” can refer to at least one of the “first range information”, and/or the “first frequency point information”, and/or the “first resource information”, and/or the “first BandWidth Part information”, and/or the “first cell information”, and/or the “first cell group information”. In one example, the second reporting indication information may be used to indicate the first node to report the “first range information” and/or the “first BandWidth Part information” for the “first frequency point information”, and/or the “first resource information”, and/or the “first cell information”, and/or the “first cell group information”, which can limit the first node to report the “first range information” and/or the “first BandWidth Part information” in the “second assistant information” only for a designated frequency point
Third reporting indication information, which indicates the first node to report assistant information related to coexistence interference regarding dual connectivity. In one embodiment, the information indicates the first node to report the “second assistant information” in the Step 1-1. Further, the information may also include frequency band information which needs to be considered when the information related to coexistence interference is reported. The specific contents of the “frequency band information” can refer to at least one of the “first range information”, and/or the “first frequency point information”, and/or the “first resource information”, and/or the “first BandWidth Part information”, and/or the “first cell information”, and/or the “first cell group information”.
Fourth reporting indication information, which indicates the first node to report assistant information related to coexistence interference regarding the sidelink. In one embodiment, the information indicates the first node to report the “first assistant information” and/or the “second assistant information” in the Step 1-1. Further, the information may also include frequency band information which needs to be considered when the information related to coexistence interference is reported. The specific contents of the “frequency band information” can refer to at least one of the “first range information”, and/or the “first frequency point information”, and/or the “first resource information”, and/or the “first BandWidth Part information”, and/or the “first cell information”, and/or the “first cell group information”
Fifth reporting indication information, which indicates the first node to report time-domain assistant information regarding coexistence interference. In one embodiment, the information indicates the first node to report the “third assistant information” in the Step 1-1
Sixth reporting indication information, which indicates the first node to report time-frequency domain assistant information regarding coexistence interference. In one embodiment, the information indicates the first node to report the “fourth assistant information” in the Step 1-1.
First transmission configuration information, which indicates configuration information required by data transmission performed when the first node performs coexistence interference avoidance. In one embodiment, the information indicates configuration information can be autonomous denied by the first node, and the autonomous denial refers to the first node can refuse uplink and/or downlink scheduling thereon by the second node (e.g., the base station). The information may include at least one piece of the following information:
Number indication information, which indicates a number of time periods which the first node can refuse. The time periods may be subframes, time slots, symbols, etc. The information may also indicate a number of scheduling (uplink and/or downlink scheduling) which the first node can refuse
Valid time information, which indicates information of a time length during which the first node performs an autonomous denial, i.e., the first node can perform autonomous denial in a time period indicated by the time length
Usage configuration information, which indicates a configuration applicable to perform autonomous denial and may include at least one piece of the following information:
Applicable frequency domain information, which indicates frequency domain information applicable to autonomous denial. Namely, a frequency band in a frequency domain indicated by the information can be autonomously refused in the time period indicated by the “valid time information”. There may be one or more frequency domain ranges indicated by the information. For one frequency domain range, the information may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”
Cell information, for the specific description thereof, please refer to the “first cell information”
Cell group information, for the specific description thereof, please refer to the “first cell group information”
Applicable interface information, which indicates information of an interface applicable to autonomous denial, such as the air interface between the first node and the second node, a sidelink interface between the first node and another node, etc.
Applicable state information, which indicates state information of the user equipment applicable to autonomous denial, such as indication information that the first node is in a connected state, indication information that the first node is in the inactive state, and indication information that the first node is in a small data transmission state

The “first assistant message” may be a Radio Resource Control (RRC) UE assistant information message or an In-Device Coexistence (IDC) interference assistant information message, or may be other messages.

The “second configuration message” may be an RRCReconfiguration message or an RRCRelease message, or may be other messages.

The “second assistant message” may be an RRC message (such as the RRC UE assistant information message or the IDC interference assistant information message), or may be a Media Access Control Control Element (MAC CE), or may be Uplink Control Information (UCI), or may be other messages.

The “first configuration message” may be an RRCReconfiguration message or an RRCSetup/Resume/Reestablishment message, or may be other messages.

The flow above has the technical effects that the first node can report the assistant information related to coexistence interference according to the configuration by the second node, and at the same time, the first node can also selectively refuse scheduling thereon by the second node (e.g., the base station) according to the configuration by the second node so as to avoid coexistence interference among various modules.

### Second Aspect: Network Side Coexistence Interference Avoidance Mechanism

When a first node performs data transmission with more than one node (for example, when the first node is in a dual connectivity state, the first node will perform data transmission with two base stations (which can be interchangably used with the node herein), or perform data transmission with two different distributed units in the same base station; and for another example, when the first node is in a small data transmission state, the first node will perform data transmission with a last serving base station and a new serving base station), signalling interaction flow among the nodes may also be included. In order to give the specific description of the signalling interaction flow among the nodes, a first network node and a second network node are defined:
When the first node is in the dual connectivity state and two network nodes connected with the first node are two different base stations, in one embodiment, the first network node and the second network node may respectively be a master base station (or a central unit of the master base station, or a control plane portion of the central unit of the master base station) and a secondary base station (or a central unit of the secondary base station, or a control plane portion of the central unit of the secondary base station), i.e., the second node and the third node above; and in another embodiment, the first network node and the second network node may respectively be the secondary base station (or the central unit of the secondary base station, or the control plane portion of the central unit of the secondary base station) and the master base station (or the central unit of the master base station, or the control plane portion of the central unit of the master base station), i.e., the third node and the second node above
When the first node is in the dual connectivity state and two network nodes connected with the first node are two different distributed units, in one embodiment, the first network node and the second network node may respectively be a central unit of a base station (or a control plane portion of the central unit of the base station) and a distributed unit serving a SCG, i.e., the fourth node and the third node above; and in another embodiment, the first network node and the second network node may respectively be the central unit of the base station (or the control plane portion of the central unit of the base station) and a distributed unit serving a MCG, i.e., the fourth node and the second node above
When the first node is in the small data transmission state, in one embodiment, the first network node and the second network node may respectively be a last serving base station (or a central unit of the base station, or a control plane portion of the central unit of the base station) and a new serving base station (or a central unit of the base station, or a control plane portion of the central unit of the base station), i.e., the second node and the third node above; and in another embodiment, the first network node and the second network node may respectively be the new serving base station (or the central unit of the base station, or the control plane portion of the central unit of the base station) and the last serving base station (or the central unit of the base station, or the control plane portion of the central unit of the base station), i.e., the third node and the second node above

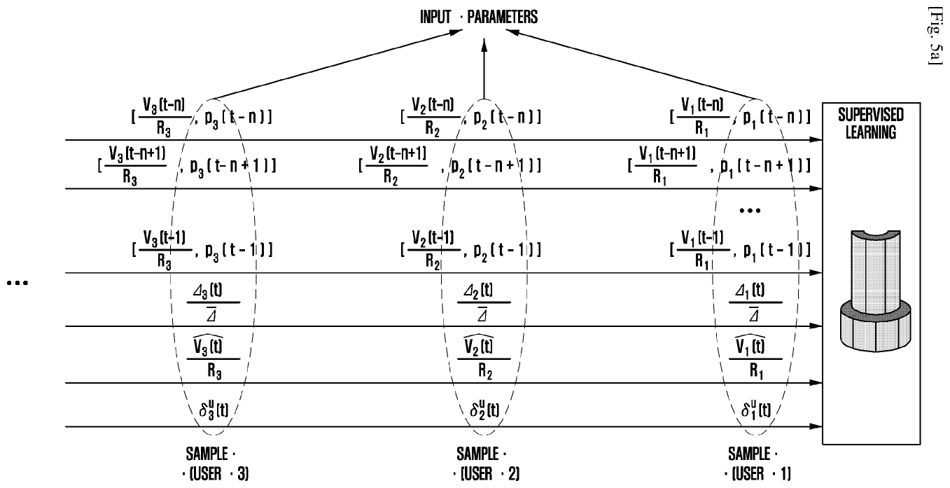

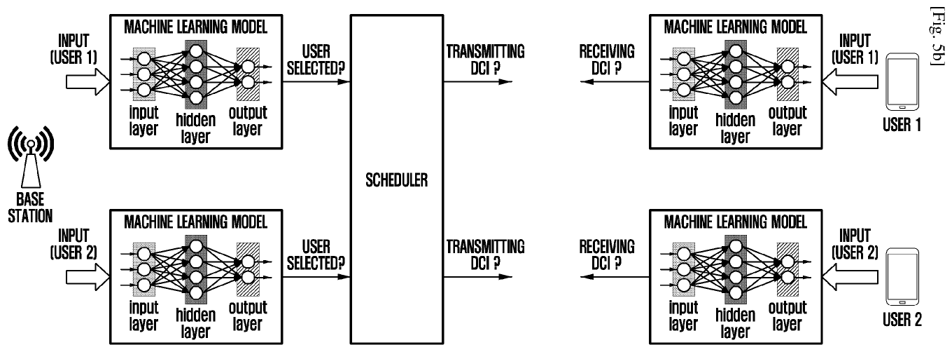

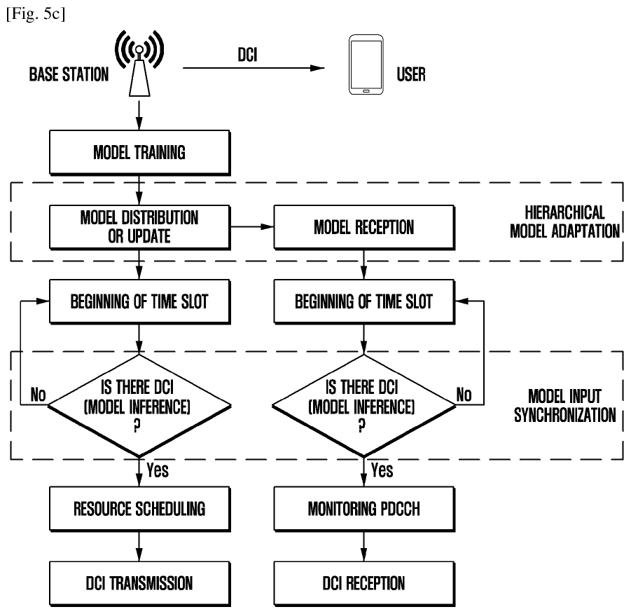

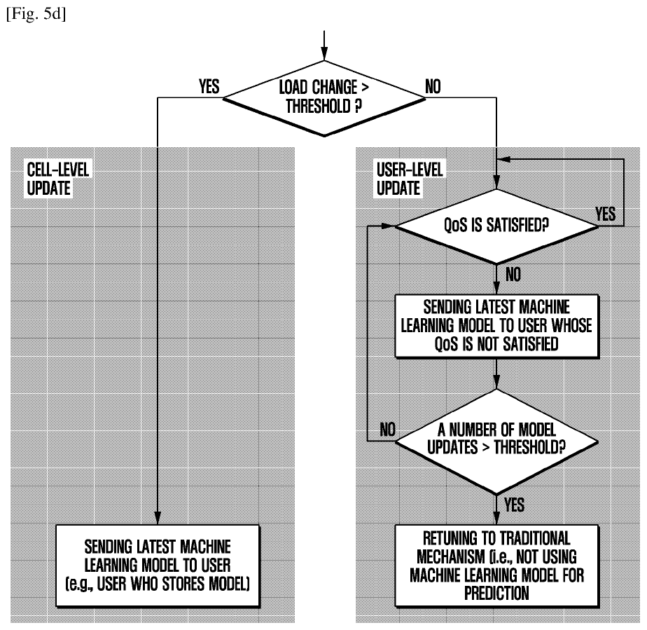

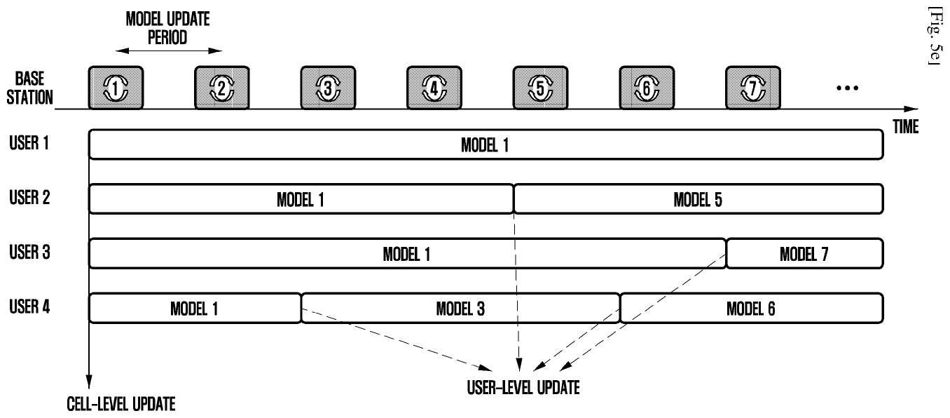

In order to avoid in-device coexistence interference, signalling interaction among the first network node, the second network node, and the first node may include exemplary flow as shown in FIG. 5. The flow may include the following steps:

Step 2-1: the first network node transmits a fifth message to the second network node. The fifth message may be a second network configuration message and the message takes the effect of providing assistant information related to coexistence interference and/or configuration information for avoiding coexistence interference to the second network node. After receiving the message, the second network node will configure the time-frequency domain resources of the user equipment. In one embodiment, the message is only transmitted when the first network node has a coexistence interference problem that cannot be solved. The message may include at least one piece of the following information:
First network assistant information. The contents of the information can refer to the “first assistant information”, and/or the “second assistant information”, and/or the “third assistant information”, and/or the “fourth assistant information” in the Step 1-1; and further, the information may also be used to indicate state information of a frequency band used by the first node. In an actual system, one implementation is that the information is the information reported by the user equipment in the Step 1-1, and another implementation is that the information is a subset of the information reported by the user equipment in the Step 1-1. Specifically, the first network node adopts a coexistence interference avoidance mechanism according to the information received in the Step 1-1, thus part of the coexistence interference problems might be solved; and if there are still some coexistence interference problems that need to be solved by the second network node, the first network node can notify the second network node through the “first network assistant information”. In one embodiment, the information indicates the state information of the first node on one or more frequency bands served by the first network node. The information has the beneficial effect that: the second network node can know the assistant information related to coexistence interference at the first node, so that the second network node is helped to generate a proper time-frequency domain configuration, thereby avoiding coexistence interference. For one frequency band, the information may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”
Cell information, for the specific description thereof, please refer to the “first cell information”
Cell group information, for the specific description thereof, please refer to the “first cell group information”
State information, which indicates a current state (such as an active state or an inactive state) of the frequency band ranges indicated by the “range information”, and/or the “frequency point information”, and/or “the resource information”, and/or the “BWP information”, and/or the “cell information”, and/or the “cell group information” included in the “first network assistant information”. The information has the beneficial effect that in a case that when the first node is in a dual-connectivity or multi-connectivity, the second network node can know a state of the first node in the frequency band served by the first network node so as to avoid that a plurality of frequency bands that serve the first node are simultaneously activated to cause coexistence interference. Further, the “active” (or “inactive) state indicates that part of frequency domain ranges indicated by the “range information”, and/or the “frequency point information”, and/or “the resource information”, and/or the “BWP information”, and/or the “cell information”, and/or the “cell group information” are in the active (or “inactive) state. Further, in order to indicate the state of the frequency domain range, the information may also indicate a time point (the time point indicates a starting time position where the frequency domain range is activated or deactivated) and/or a time length when the frequency domain range is to be activated or deactivated
First network configuration information, which includes a configuration of a time-frequency domain provided by the first network node. In one embodiment, the configuration information is configuration information about a configuration of the first node in a frequency band/a cell served by the first network node given by the first network node, and further, the configuration is a configuration after the first network node adopts the coexistence interference avoidance mechanism or a configuration caused by a coexistence interference avoidance mechanism to be adopted; and in another embodiment, the configuration information is configuration information about a configuration required by the first node in a frequency band/a cell served by the second network node given by the first network node, and further, the configuration is a configuration given by the first network node and used by the second network node to perform coexistence interference avoidance. The information has the beneficial effect that: the second network node can know the configuration information for coexistence interference avoidance, so that the second network node is helped to perform data transmission with the first node according to the configuration, thereby avoiding coexistence interference. The information may include at least one piece of the following information:
Second frequency domain configuration information, which indicates a configuration of a frequency domain and may include at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”
Cell information, for the specific description thereof, please refer to the “first cell information”
Cell group information, for the specific description thereof, please refer to the “first cell group information”
First state configuration information, which indicates a current state (such as states of activating, deactivating a specific frequency domain range, etc.) of the frequency domain ranges indicated by the “range information”, and/or the “frequency point information”, and/or “the resource information”, and/or the “BWP information”, and/or the “cell information”, and/or the “cell group information” in the “second frequency domain configuration information”. Further, the first state configuration information may also include time length information of the active/inactive state. Further, the “active” (or “inactive”) indicates that part of the frequency domain ranges indicated by the “range information”, and/or the “frequency point information”, and/or “the resource information”, and/or the “BWP information”, and/or the “cell information”, and/or the “cell group information” are in the “active” (or “inactive”) state. Further, in order to indicate the state of the frequency domain range, the information may also indicate a time point (the time point indicates a starting time position where the frequency domain range is activated or deactivated) and/or a time length when the frequency domain range is to be activated or deactivated
First state setting information, which indicates a state (such as an active state or an inactive state, etc.) of the frequency domain ranges indicated by the “range information”, and/or the “frequency point information”, and/or “the resource information”, and/or the “BWP information”, and/or the “cell information”, and/or the “cell group information” in the “second frequency domain configuration information” set (or prepared to be set) by the first network node. Further, the first state setting information may also include time length information of the active/inactive state. Further, in order to indicate the state of the frequency domain range set (or prepared to be set) by the first network node, the information may also indicate a time point (the time point indicates a starting time position where the frequency domain range is activated or deactivated) and/or a time length when the set frequency domain range is activated or deactivated. The state setting information is set by the first network node according to the information (such as the information included in the first message in the Step 1-1) which is reported by the user equipment and related to coexistence interference. In addition, the information may further be used to indicate a behaviour of the first network node for the frequency domain ranges indicated by the “range information”, and/or the “frequency point information”, and/or “the resource information”, and/or the “BWP information”, and/or the “cell information”, and/or the “cell group information” in the “second frequency domain configuration information”, such as a behaviour of changing the used frequency domain range (e.g., switching a cell, switching a BWP, etc.), and a behaviour of retaining the used frequency domain range (e.g., not performing cell switch, and not performing BWP switch). The second network node determines the state of the frequency domain range used by the second network node according to the behaviour indication information
First state request information, which indicates a request for a state of the frequency domain ranges indicated by the “range information”, and/or the “frequency point information”, and/or “the resource information”, and/or the “BWP information”, and/or the “cell information”, and/or the “cell group information” in the “second frequency domain configuration information”, such as a request for activating a frequency domain range, a request for deactivating a frequency domain range, etc. Further, the first state request information may also include time length information of the requested active/inactive frequency domain ranges. In one embodiment, the frequency domain range at which the “first state request information” aims is a frequency domain range served by the second network node
First time domain configuration information, which indicates a configuration of a time domain. The information may include at least one piece of the following information:
Time domain information, for the specific contents thereof, please refer to the “third time-domain information”
Usage indication information, which indicates an applicable range of the “time domain information” in the “first time domain configuration information”, for the specific contents thereof, please refer to the “third usage indication information”
First time-frequency domain configuration information, which indicates a configuration of a time-frequency domain. The information may include at least one piece of the following information:
Time domain information, which indicates one time period on a time domain. The specific contents can refer to the “four time domain information”
Usage indication information, which indicates frequency domain information applicable (or inapplicable) to use (or cannot use) in the time period indicated by the “time domain information” in the “first time-frequency domain configuration information”. The specific contents can refer to the “fourth usage indication information”
Frequency domain usage pattern information, which indicates one pattern of using each frequency band in the frequency domain. The specific contents of the information can refer to the description of the “fourth frequency domain usage pattern information”
Second configuration information, which specifically indicates configuration information required by data transmission performed when the first node performs coexistence interference avoidance. In one embodiment, contents included by the information may be contents included in the “second configuration message”
First interference indication information, which indicates whether the first node has coexistence interference at the first network node, or indicates whether the first network node performs coexistence interference avoidance of the first node, or indicates whether the first network node can avoid coexistence interference at the first node, so that the second network node can be helped to decide whether to perform a coexistence interference avoidance mechanism. The information may be explicit information, or may be implicit information. For the implicit information, if the first network node has no proper coexistence interference avoidance mechanism, the “fifth message” or one or more information in the “first network assistant information” included in the “fifth message”, or one or more information in the “first network configuration information” included in the “fifth message” which is transmitted by the first network node, can be used to implicitly indicate that coexistence interference still exists at the first node, and then the second network node needs to perform the coexistence interference avoidance mechanism according to received information.

Step 2-2: the second network node transmits a second message to the first node. The second message may be a third configuration message, and the message takes the effect of performing the configuration of the time domain and/or the frequency domain of the first node so as to avoid coexistence interference. The contents in the message can refer to the “second configuration message” in the Step 1-2. Optionally, the third configuration message may be generated by the second network node on the basis of the second network configuration message received in the Step 2-1.

Optionally, before the Step 2-1, Step 2-0 may also be included, i.e., the first node provides assistant information related to coexistence interference to the first network node. The contents included by the information can refer to the first assistant message in the Step 1-1. Optionally, the second network configuration message may be generated by the first network node on the basis of the first assistant message received from the first node in the Step 2-0.

The “second network configuration message” may be a Handover Request message, or a Handover Request Response message, or a Secondary Node Addition/Modification Request message, or a Secondary Node Modification Required message, or a Context Retrieve Response message, or a Context Retrieve Request message, or a Partial Context Rransfer message, or a Partial Context Transfer Acknowledgement message, or may be a newly defined inter-base-station interface message.

The “third configuration message” may be the “second configuration message” which may be an RRCReconfiguration message or may be other messages.

Various implementations of coexistence interference avoidance in various scenes are given below. In the following illustration, one frequency band can be indicated by at least one piece of the following information:
Range information, for the specific description thereof, please refer to the “first range information”
Frequency point information, for the specific description thereof, please refer to the “first frequency point information”
Resource information, for the specific description thereof, please refer to the “first resource information”
BWP information, for the specific description thereof, please refer to the “first BandWidth Part information”
Cell information, for the specific description thereof, please refer to the “first cell information”
Cell group information, for the specific description thereof, please refer to the “first cell group information”

### Implementation 1: The First Node is in the Dual Connectivity State, the First Node is Connected to the Second Node and the Third Node, and the Second Node and the Third Node May be Two Different Base Stations

In this implementation, when the first node reports the assistant information related to coexistence interference, a combination (such as the “second assistant information”) of a plurality of frequency bands will be indicated, and when the first node simultaneously uses these frequency bands, a coexistence interference will be caused. However, these different frequency bands are respectively controlled by the second node and the third node, so both the second node and the third node cannot completely know states of the plurality of frequency bands. In order to avoid coexistence interference, an existing feasible method is that both the second node and the third node do not use these frequency bands to perform data transmission with the first node. Such method causes unnecessary resource waste, because in practice, as long as at least one of the plurality of frequency bands is not used by the first node, there will be no coexistence interference problem. In order to avoid the unnecessary resource waste, the present disclosure discloses the following possible methods:

### Method 1: A Network Determines Usage of Various Frequency Bands on the Basis of a State Reported by the First Node

In this method, in one embodiment, the first node may transmit the “second assistant information” to the second node in Step 1-1, the information indicates state information (such as the “second state information” in the “second frequency domain information”) of various frequency bands, and according to the information, the second node can determine whether to activate a frequency band indicated in the information and served by the second node; further, the second node can transmit the received “second assistant information” to the third node (e.g., Step 2-1), and the third node can determine whether to activate a frequency band indicated in the information and served by the third node; in another embodiment, the first node can transmit the “second assistant information” included in the Step 1-1 to the third node, the information indicates the state information of various frequency bands, and according to the information, the third node can determine whether to activate the frequency band indicated in the information and served by the third node; and further, the third node can transmit the received “second assistant information” to the second node (e.g., Step 2-1), and the second node can determine whether to activate the frequency band indicated in the information and served by the second node.

In the flow above, the first node can transmit information to the second node or the third node through an RRC message (e.g., Step 1-1). Further, after the first node transmits the “second assistant information” (the information indicates a combination of frequency bands that cause coexistence interference) to the second node or the third node, the state information of various frequency bands can also be respectively reported in real time to the second node and the third node (reporting in real time can be implemented through the MAC CE, or the UCI, or the RRC), and as described in the Step 1-1a, the first node transmits the state information of a frequency band served by the third node to the second node, so that the second node decides whether to use a frequency band served by the second node, and the first node transmits the state information of a frequency band served by the second node to the third node, so that the third node decides whether to use a frequency band served by the third node.

The method has the beneficial effect that the second node (or the third node) can determine a configuration (such as a configuration for activating or deactivating one frequency band, e.g., the configuration in the Step 1-2) of the frequency band served by the second node (or the third node) according to the received states of various frequency bands that serve the first node so as to avoid all the frequency bands in the combination of a plurality of frequency bands which cause coexistence interference simultaneously serve the user equipment.

### Method 2: A Network Configures States of Various Frequency Bands

In this method, in one embodiment, the first node may transmit the “second assistant information” to the second node in Step 1-1, the information indicates a combination of frequency domain ranges that cause coexistence interference, according to the information, the second node can transmit the second network configuration message in the Step 2-1 to the third node, the message may include the “first network configuration information”, the information indicates a configuration (such as the “first state request information”, the “first state configuration information”, the “first time domain configuration information”, the “first time-frequency domain configuration information”, etc.) by the second node on a frequency band served by the third node, and the third node configures the frequency band of the third node for serving the first node according to the received second network configuration message; and in another embodiment, the first node may transmit the “second assistant information” to the third node in Step 1-1, the information indicates a combination of frequency domain ranges that cause coexistence interference, according to the information, the third node can transmit the second network configuration message in the Step 2-1 to the second node, the message may include the “first network configuration information”, the information indicates a configuration (such as the “first state request information”, the “first state configuration information”, the “first time domain configuration information”, the “first time-frequency domain configuration information”, etc.) by the third node on a frequency band served by the second node, and the second node configures the frequency band of the second node for serving the first node according to the received second network configuration message.

The method has the beneficial effect that the second node (or the third node) can generate a configuration (such as a configuration of activating or deactivating one frequency band, e.g., the configuration in Step 2-1) of the frequency band served by the third node (or the second node) according to the received assistant information from the first node so as to avoid all the frequency bands in the combination of a plurality of frequency bands which cause coexistence interference simultaneously serve the user equipment.

### Implementation 2: Solution of Coexistence Interference Problem of User Equipment During Inactive State

Before the user equipment enters the inactive state, the user equipment might discover the coexistence interference problem, or a base station serving the user equipment performs configuration of coexistence interference avoidance on the user equipment. After entering the inactive state, the user equipment might perform data transmission, i.e., small data transmission, during the inactive state. In the small data transmission process, the coexistence interference problem may cause a failure of small data transmission. In an existing mechanism, the user equipment has released a configuration related to coexistence interference during small data transmission (for example, the user equipment cannot report the coexistence interference problem), resulting in that the coexistence interference problem in the small data transmission process cannot be solved. In order to solve this technical problem, the present disclosure proposes two methods:

### Method 1: When the User Equipment is Configured to be in the Inactive State, ConFiguration of a Coexistence Interference Avoidance Mechanism is Performed on the User Equipment

In this method, when the second node releases the first node to be in the inactive state, the second node can transmit configuration information for avoiding coexistence interference to the first node, and specifically, the configuration information may be the information in the second configuration message in the Step 1-2. In one embodiment, the configuration information may be included in an RRC Release message. In one embodiment, after receiving the “first frequency domain configuration information” in the second configuration message, the first node can use the frequency band indicated in the information to perform small data transmission; in another embodiment, after receiving the “first time domain configuration information” in the second configuration message, the first node can determine a used time-domain configuration according to the frequency band used when small data transmission is performed; and in yet another embodiment, after receiving the “first time-frequency domain configuration information” in the second configuration message, the first node can select the frequency bands used in different time periods according to the configuration. In still a further embodiment, when receiving the “second transmission configuration information” in the second configuration message, the first node can perform autonomous denial in the small data transmission process according to the configuration. In one additional embodiment, when receiving the “indication information of retaining a configuration”, the first node can retain the configuration for avoiding coexistence interference so as to avoid coexistence interference in the inactive state.

The method has the beneficial effect that when the first node starts small data transmission after entering the inactive state, the first node can determine the configuration of the time-frequency domain for small data transmission according to the configuration information for avoiding coexistence interference so as to avoid coexistence interference in the small data transmission process.

### Method 2: The User Equipment is Configured to Perform Coexistence Interference Avoidance in the Small Data Transmission Process Performed by the User Equipment

In this method, the user equipment discovers coexistence interference when performing small data transmission, and needs the network side to help to solve this problem. In the prior art, the user equipment cannot provide information of coexistence interference to the network side in the inactive state, so the network cannot help the user equipment to solve the coexistence interference problem.

In one implementation, the first node can perform data transmission according to the configuration information for avoiding coexistence interference, which is stored when the first node enters the inactive state, so as to avoid coexistence interference. In this implementation, when transmitting the RRC message (such as the RRC Release message) to the first node, the first network node can provide the configuration information (such as the information included in the “second configuration message”) for avoiding coexistence interference to the first node. Further, when the first node performs small data transmission through the second network node and the context of the first node is still stored at the first network node, the first network node can transmit the “second network configuration message” to the second network node, and the second network node can know the configuration information for avoiding coexistence interference, which is stored at the first node, according to the information, and perform small data transmission with the first node by utilizing the configuration information. Further, when the first node accesses the network through the distributed unit controlled by the second network node, the second network node can also transmit the received information in the “second network configuration message” to the distributed unit, so that the distributed unit adopts the proper configuration to avoid coexistence interference. Such implementation has the beneficial effect that the first node can perform data transmission by adopting the configuration for avoiding coexistence interference, which is obtained when the first node enters the inactive state.

In another implementation, the first node can provide assistant information related to coexistence interference to the network side in the process of performing small data transmission. When the first node accesses the network through the second network node and the context of the first node is stored at the first network node, the first node can transmit the assistant information (such as the information included in the first assistant message in the Step 1-1) related to coexistence interference to the second network node, and then the information is forwarded to the first network node by the second network node. Hereafter, modes which might be adopted by the first network node include:

1) Mode 1: the first network node can transmit the assistant information to the second network node, and then the second network node generates the configuration information (such as the information included in the second configuration message in the Step 1-2) for avoiding coexistence interference and transmits the configuration information to the first node. Further, when the first node accesses the network through the distributed unit controlled by the second network node, the second network node can also transmit the information in the “second configuration message” to the distributed unit, so that the distributed unit adopts the proper configuration to avoid coexistence interference

2) Mode 2: the first network node can generate the configuration information for avoiding coexistence interference and then transmit the configuration information to the second network node (such as the information included in the second network configuration message in the Step 2-1), and the second network node performs small data transmission with the first node according to the configuration information. Further, when the first node accesses the network through the distributed unit controlled by the second network node, the second network node can also transmit the received information in the “second network configuration message” to the distributed unit, so that the distributed unit adopts the proper configuration to avoid coexistence interference

The method has the beneficial effects that the second network node can obtain the assistant information related to coexistence interference from the first network node at which the first node locates when entering the inactive state so as to generate the configuration information for avoiding coexistence interference, and/or the second network node can obtain the configuration information for avoiding coexistence interference from the first network node so as to avoid the data transmission problem caused by coexistence interference in the process of performing small data transmission with the first node.

### Third Aspect: Prediction of User Scheduling

Another aspect of the present disclosure is to predict scheduling information for a user. A technical problem to be solved in this aspect is that, when a base station schedules the user, what is used is information of an entire network that the base station has mastered, which facilitates the base station making most effective scheduling decision. However, since the user cannot obtain the information of the entire network, the user fails to predict in which time slots the base station will schedule it, so the user needs to monitor the scheduling information of the base station in each configured time slot (for example, Downlink Control Information (DCI) carried by a Physical Downlink Control Channel (PDCCH)), so as to determine whether the user is scheduled by the base station. A biggest problem with this method is that the user may not obtain the user's scheduling information after monitoring the PDCCH, which leads to energy consumption of the user (monitoring of the PDCCH will lead to large energy consumption). In order to solve this problem, the present disclosure proposes a method for predicting scheduling information based on artificial intelligence, which can help the user predict scheduling information (such as presence or absence of DCI, or monitoring of the PDCCH), so that user monitors the PDCCH only in the time slot where DCI appears. By using this method, the energy consumption of the user can be greatly reduced, and the use time of the user terminal equipment is extended.

The method for predicting scheduling information based on artificial intelligence includes two parts of contents of invention:
Part 1: Design of scheduling algorithm based on artificial intelligence, or design of scheduling algorithm based on machine learning. The following description takes a machine learning model as an example.

The scheduling algorithm based on artificial intelligence consists of two steps:

Step A-1: the base station uses input parameters of each user as an input of the machine learning model, and an inference result of the model indicates whether the user is selected, e.g., “0” means not selected, and “1” means selected; in this step, for a user, the input parameters of the machine learning model include at least one of following parameters:
Ratio of a rate achieved by the user to a rate requirement, Vᵢ(*)/Rᵢ. In one example, a ratio of past multiple time slots can be input to the machine learning model. For a rate achieved by the user in time slot t, a formula below can be satisfied:

$${V}_{i} ( t ) = \frac{1}{2} {\sum }_{k = 1}^{t} {δ}_{i}^{u} ( k ) {v}_{i} ( k ) \geq {R}_{i}$$

The above formula can be further transformed into

$$\begin{matrix}\frac{1}{t} \frac{{δ}_{i}^{u} ( t ) {v}_{i} ( t )}{{R}_{i}} \geq 1 - \frac{t - 1}{t} \frac{{V}_{i} ( t - 1 )}{{R}_{i}} \\ > 1 - \frac{{V}_{i} ( t - 1 )}{{R}_{i}} \\ > 1 - \frac{{p}_{i} ( t - 1 ) \overline{{v}_{ι} ( t - 1 )}}{{R}_{i}}\end{matrix}$$

wherein Vᵢ(t−1) can be calculated according to a formula below:

$$\begin{matrix}{V}_{i} ( t - 1 ) = \frac{1}{t - 1} {\sum }_{k = 1}^{t - 1} {δ}_{i}^{u} ( k ) {v}_{i} ( k ) . \\ = \overline{{v}_{ι} ( t - 1 )} \frac{{\sum }_{k = 1}^{t - 1} {δ}_{i}^{u} ( k )}{t - 1} \\ = {p}_{i} ( t - 1 ) {v}_{i} ( t - 1 )\end{matrix}$$

wherein

$${δ}_{i}^{u} ( t )$$

is a user selection decision (e.g., 1 means the user is selected, 0 means the user is not selected). pᵢ(t−1) is the user's scheduling probability (in one embodiment, the scheduling probability is one scheduling probability except the scheduling of retransmissions).

$$\overline{{v}_{ι} ( t - 1 )} ( ∈ [ {v}_{i}^{min} , {v}_{i}^{max} ] )$$

is the user's effective rate, wherein

$${v}_{i}^{min} and {v}_{i}^{max}$$

are the user's maximum and minimum instantaneous rates, respectively.
The user's scheduling probability pᵢ(*). In one example, the scheduling probabilities of past multiple time slots can be input to the machine learning model.
Normalized non-scheduling time slot Δᵢ(t)/Δ̅, wherein Δᵢ(t) represents a number of time slots passed after a last scheduling, and Δ̅ is a normalized parameter.
Ratio of a predicted user rate to the rate requirement [symbol] /Rᵢ, wherein [symbol] represents a maximum rate that the user can achieve when all bandwidth in the time slot t is allocated to the user.

When training the model, it can be carried out in a manner shown in FIG. 5a. Each sample belongs to a user and contains Vᵢ(*)/Rᵢ (of the past multiple time slots), [symbol] /Rᵢ, and

$${δ}_{i}^{u} ( t ) .$$

Step A-2: for selected users indicated by the model inference result, the base station allocates bandwidth to these selected users through a scheduler, and finally transmits DCI to the users allocated with bandwidth.
Part 2: Adaptive Synchronization of AI Models

In this part, the base station will send the trained machine learning model to the user, and then the base station and the user sides can use a same model for inference. As shown in FIG. 5b, the base station uses a same machine learning model to perform inference for different users, and the inference result determines whether to select the corresponding user for scheduling. Because different users input different parameters to the model, inference results may also be different. On the user side, each user uses the same model as the base station to perform inference to determine whether to monitor the PDCCH based on the inference result. For a user, if the base station side and the user side input same parameters to the machine learning model, the base station side and the user side will produce the same inference result.

A flowchart for deploying the machine learning model to a user is shown in FIG. 5c. For the base station side, the base station first trains the model, and then distributes the trained model to the user or updates the model on the user side. After that, at the beginning of a time slot, the base station uses the model to perform inference to determine whether to select the user for scheduling. If scheduling is required, a scheduling algorithm will be used to allocate resources to selected users, and finally the base station transmits DCI to the users allocated with resources. On the user side, the user receives the machine learning model sent by the base station. At the beginning of a time slot, the user uses the model to perform inference to determine whether it needs to monitor the PDCCH or not. If the inference result indicates that the PDCCH needs to be monitored, the user performs reception of DCI in the time slot. Through the flow in FIG. 5c, the base station and the user can use the same machine learning model to perform inference.

Adaptive synchronization of AI models consists of two aspects: 1) hierarchical model adaptation and 2) synchronization of model inputs.

### 1) Hierarchical Model Adaptation

The base station will perform online model training, and the online model training may be performed periodically. After the base station obtains the machine learning model, it will update the model at a cell level or at a user level. These two updating methods can achieve a balance between user's QoS and air interface bandwidth requirements. Flowcharts of these two updating methods are shown in FIG. 5d.

### Cell-Level Update

When a cell load change is large, e.g., when a cell load change is beyond a certain threshold, the base station can send a latest machine learning model to a user (such as a user who is deployed with a model), and one deployment method of this model can be broadcast

### User-Level Update

When the cell load change is small, e.g., when the cell load change is lower than a certain threshold, if the user's QoS is not satisfied, the base station can send the latest machine learning model to the user whose QoS is not satisfied, and a deployment method of this model can be unicast. In order to avoid frequent model updates, if a number of user model updates exceeds a certain threshold, the base station will send a fallback instruction to the user, which instructs the user to stop using the machine learning model for prediction of PDCCH monitoring (scheduling information), that is, to use a traditional PDCCH monitoring mechanism.

After performing the above cell-level update and user-level update, FIG. 5e shows an example of model update for 4 users. The user-level update results in model updates for different users at different points in time. Therefore, different users may use different models for DCI prediction. At the same time, in order to ensure that the base station and the user can perform model inference simultaneously, the base station can indicate the time to use the model when sending the model to the user.

In order to calculate energy saving brought by the above mechanism, it is necessary to consider energy consumed by the user for PDCCH monitoring and energy consumed for model inference, for example

$${E}_{TANGO} = {N}_{acct} * {P}_{ML} + {N}_{pm} * {P}_{pm}$$

wherein N_{act} represents a number of time slots in which the user can monitor PDCCH, and in these time slots, the user needs to perform model inference in each time slot; Nₚₘ represents a number of time slots for PDCCH monitoring, and this number is the number of time slots in which the model inference indicates that the user needs to monitor the PDCCH.
P_{ML} and Pₚₘ represent the energy consumption of model inference and the energy consumption of PDCCH monitoring, respectively. An energy saving gain brought by the above mechanism can be expressed by a formula below:

$$Gain = \frac{{E}_{Trad} - {E}_{TANGO}}{{E}_{Trad}} = 1 - \frac{{N}_{pm}}{{N}_{act}} - \frac{{P}_{ML}}{{P}_{pm}}$$

When 1−Nₚₘ/N_{act} is 70%, the energy saving gain is:

$$Gain \approx 70 \% - {P}_{ML} / {P}_{pm}$$

Furthermore, in addition to realize energy saving, the above-mentioned method for predicting scheduling information based on artificial intelligence can also be used in other scenarios to bring other benefits to users. The following uses several different scenarios to illustrate other benefits of the above-mentioned method for predicting scheduling information based on artificial intelligence.

### Latency Reduction

In order to extend coverage of the base station, a sidelink relay technology is introduced. In this technology, a relay node (such as a relay terminal) will use an air interface (such as a Uu link) to communicate with a base station, and use a sidelink (such as a PC5 link) to communicate with a remote terminal. In this way, data packets from the base station to the remote terminal can be transmitted through the relay terminal. In order to solve interference between the Uu link and the PC5 link, Time Division Multiplexing (TDM) can be used to allocate working time of the two links, that is, a time period when the relay terminal works on the Uu link will be different from a time period when it works on the PC5 link, as shown in FIG. 5f(a). This TDM method will increase latency of data packets sent from the base station to the remote user, because the relay terminal can use the PC5 link to send data packets for the remote terminal only after the time period allocated to the Uu link ends. After in-troducing the above method of predicting scheduling information based on artificial intelligence, the relay terminal can predict a time slot in which DCI appears on the Uu link. If the relay terminal predicts that DCI will not appear in a time slot, the relay terminal can immediately use the time slot to send data packets to the remote terminal through the PC5 link, as shown in FIG. 5f(b). By using this method, the relay terminal can use the PC5 link to send data packets to the remote terminal in a more timely manner, thereby reducing the latency in data packet transmission.

### Throughput Improvement

A user terminal may contain multiple transceivers, such as transceivers access to 4G/5G, transceivers access to other Radio Access Technologies (RATs) (such as a wireless local area network (WIFI) transceiver, a Bluetooth transceiver). Since these transceivers are relatively close to each other and their operating frequencies are relatively close, there will be interference between these transceivers, that is, coexistence interference, as introduced in the first aspect and the second aspect of the present disclosure. In order to solve the coexistence interference between different transceivers, a possible method is to use time division multiplexing, that is, a 4G/5G transceiver and a transceiver of other RATs work in different time periods. In this way, the transceiver of other RATs cannot perform data transmission during the time period allocated to the 4G/5G transceiver, even if the base station does not schedule the user during the time period allocated to the 4G/5G transceiver, which reduces user throughput. In order to solve this problem, the above method for predicting scheduling information based on artificial intelligence can help the user obtain more scheduling opportunities. For example, when the user predicts that the 4G/5G transceiver does not need to receive DCI, the user can use transceiver of other RATs to transmit data within the time slot. Moreover, the user's 4G/5G transceiver can also perform data transmission within the time allocated to other RATs, that is, within the time allocated to other RATs, if the above-mentioned method for predicting scheduling information based on artificial intelligence predicts that the 4G/5G transceiver needs to receive DCI, the user can use the 4G/5G transceiver for data transmission. In this way, both the 4G/5G transceiver and the transceiver of other RATs obtain more time for data transmission, thereby improving user throughput.

### Reduction of Interruptions During Movement

In order to complete the user's movement, before receiving a handover instruction, the user may need to perform operations related to handover preparation, such as measuring neighbor cells, performing uplink and downlink synchronizations with the neighbor cells, and so on. These operations need to allocate dedicated resources for the user, such as measurement gaps, which are resources in time domain used for uplink and downlink synchronizations. In an existing mechanism, the dedicated resources required for these operations cause the user to interrupt communication with a source cell, which introduces an additional interruption of the communication with the source cell. If the above method for predicting scheduling information based on artificial intelligence is used, the user can predict a time slot that the base station of the source cell does not schedule the user, and then the user can use this time slot to perform measurement of neighbor cells or uplink and downlink synchronization, thereby reducing interruption of communication with the source cell.

In practice, in order to implement the above method for predicting scheduling information based on artificial intelligence, the following two aspects need to be further considered:
Training of machine learning model: machine models can be trained on the base station side or at a central node (such as a Network Data Analytics Function (NWDAF) entity). Further, the central node may perform model training for base stations of a same manufacturer, and then distribute the trained model to the base stations belonging to the manufacturer.
Deployment of the machine learning model: when deploying this model, the base station can download an application program or signaling (such as Radio Resource Control (RRC) signaling, and Non-Access Stratum (NAS) signaling). Further, when the user hands over between different base stations, the target base station can determine whether it needs to update the user model. If a target base station and a source base station belong to different manufacturers, then the target base station needs to update the model.

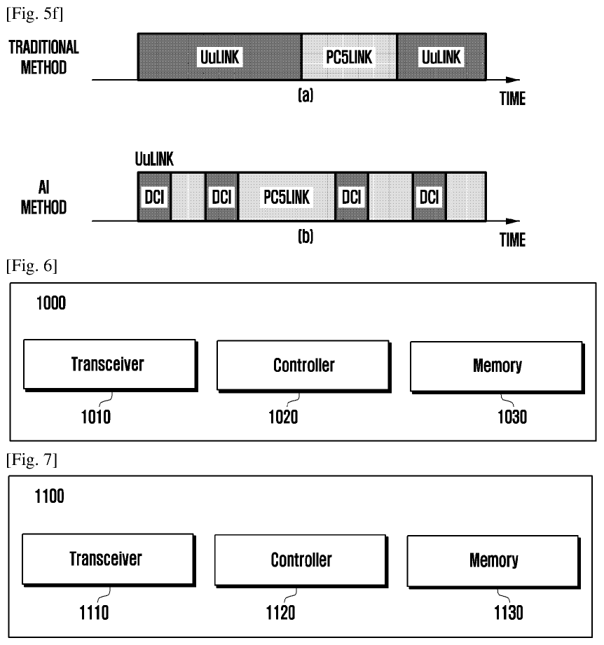

FIG. 6 is a block diagram of a node according to an exemplary embodiment of the present disclosure. Here, a node is taken as an example to illustrate its structure and function. However, it should be understood that the structure and function shown can also be applied to a base station (or a central unit of the base station, or a control plane portion of the central unit of the base station, or a user plane portion of the central unit of the base station, or a distributed unit of the base station, etc.).

Referring to FIG. 6, a node 1000 includes a transceiver 1010, a controller 1020, and a memory 1030. Under the control of the controller 1020 (which may be implemented as one or more processors), the node 1000 (including the transceiver 1010 and the memory 1030) is configured to perform the operations of the node described above. Although shown as separate entities, the transceiver 1010, the controller 1020, and the memory 1030 may be implemented as a single entity, such as a single chip. The transceiver 1010, the controller 1020, and the memory 1030 may be electrically connected or coupled to each other. The transceiver 1010 may transmit a signal to and receive a signal from other network entities, such as another node and/or a UE, etc. In one implementation, the transceiver 1010 may be omitted. In this case, the controller 1020 may be configured to execute instructions (including computer programs) stored in the memory 1030 to control the overall operation of the node 1000, thereby implementing the operations of the node described above.

FIG. 7 is a block diagram of a user equipment according to an exemplary embodiment of the present disclosure. In the present application, the terms “user equipment”, “user terminal device”, “user terminal”, and “terminal device” may be used interchangeably.

Referring to FIG. 7, a user equipment 1100 includes a transceiver 1110, a controller 1120, and a memory 1130. Under the control of the controller 1120 (which may be implemented as one or more processors), the user equipment 1100 (including the transceiver 1110 and the memory 1130) is configured to perform the operations of the user equipment described above. Although shown as separate entities, the transceiver 1110, controller 1120, and memory 1130 may be implemented as a single entity, such as a single chip. The transceiver 1110, the controller 1120, and the memory 1130 may be electrically connected or coupled to each other. The transceiver 1110 may transmit a signal to and receive a signal from other network entities, such as a node, another UE, or the like. In one implementation, the transceiver 1110 may be omitted. In this case, the controller 1120 may be configured to execute instructions (including computer programs) stored in the memory 1130 to control the overall operation of the user equipment 1100, thereby performing the operations of the user equipment described above.

Those skilled in the art may realize that the present disclosure can be implemented in other specific forms without changing the technical idea or basic features of the present disclosure. Therefore, it should be understood that the above-mentioned embodiments are merely examples and not limitative. The scope of the present disclosure is defined by the appended claims rather than the detailed description. Therefore, it should be understood that all modifications or changes derived from the meaning and scope of the appended claims and their equivalents fall within the scope of the present disclosure.

In the above-described embodiments of the present disclosure, all operations and messages may be selectively performed or may be omitted. In addition, the operations in each embodiment do not need to be performed sequentially, and the order of operations may vary. Messages do not need to be transmitted sequentially, and the transmission order of messages may change. Each operation and transfer of each message can be performed independently.

Although the present disclosure has been illustrated and described with reference to various embodiments of the present disclosure, those skilled in the art will understand that various changes can be made in form and detail without departing from the spirit and scope of the present disclosure as defined by the appended claims and their equivalents.

1-15. (canceled)

16. A method performed by a first node in a communication system, the method comprising:
receiving, from a terminal, a first message including at least one of assistance information on a frequency range combination associated with an in-device coexistence (IDC) problem, or assistance information on a time domain associated with the IDC problem; and
transmitting, to a second node, a second message including at least one of the assistance information on the frequency range combination associated with the IDC problem, or the assistance information on the time domain associated with the IDC problem, when the IDC problem is not processed by the first node,
wherein the assistance information on the frequency range combination associated with the IDC problem, or the assistance information on the time domain associated with the IDC problem is for dual connectivity.

17. The method of claim 16, further comprising transmitting, to the terminal, a third message including at least one of information for the terminal to report assistance information about the IDC problem associated with a frequency range, or information for the terminal to report assistance information about the IDC problem associated with the time domain,
wherein the information for the terminal to report the assistance information about the IDC problem associated with the frequency range includes information on the frequency range considered when reporting the IDC problem, and
wherein the information on the frequency range includes information on a frequency and information on a bandwidth associated with the frequency.

18. The method of claim 16, wherein the assistance information on the frequency range combination associated with the IDC problem includes at least one of information on a frequency range affected by the IDC problem, inference direction information, or information on a system influenced by the IDC problem.

19. The method of claim 16, wherein the assistance information on the time domain associated with the IDC problem includes at least one of information on a cycle length, information on a start offset, or information on an active duration.

20. A method performed by a second node in a communication system, the method comprising:
receiving, from a first node, a second message including at least one of assistance information on a frequency range combination associated with an in-device coexistence (IDC) problem, or assistance information on a time domain associated with the IDC problem, when the IDC problem is not processed by the first node,
wherein a first message including at least one of the assistance information on the frequency range combination associated with the IDC problem, or the assistance information on the time domain associated with the IDC problem is transmitted from a terminal to the first node, and
wherein the assistance information on the frequency range combination associated with the IDC problem, or the assistance information on the time domain associated with the IDC problem is for dual connectivity.

21. The method of claim 20, wherein a third message including at least one of information for the terminal to report assistance information about the IDC problem associated with a frequency range, or information for the terminal to report assistance information about the IDC problem associated with the time domain is transmitted from the first node to the terminal,
wherein the information for the terminal to report the assistance information about the IDC problem associated with the frequency range includes information on the frequency range considered when reporting the IDC problem, and
wherein the information on the frequency range includes information on a frequency and information on a bandwidth associated with the frequency.

22. The method of claim 20, wherein the assistance information on the frequency range combination associated with the IDC problem includes at least one of information on a frequency range affected by the IDC problem, inference direction information, or information on a system influenced by the IDC problem.

23. The method of claim 20, wherein the assistance information on the time domain associated with the IDC problem includes at least one of information on a cycle length, information on a start offset, or information on an active duration.

24. A first node in a communication system, the first node comprising:
a transceiver; and
at least one processor coupled with the transceiver and configured to:
receive, from a terminal, a first message including at least one of assistance information on a frequency range combination associated with an in-device coexistence (IDC) problem, or assistance information on a time domain associated with the IDC problem, and
transmit, to a second node, a second message including at least one of the assistance information on the frequency range combination associated with the IDC problem, or the assistance information on the time domain associated with the IDC problem, when the IDC problem is not processed by the first node,
wherein the assistance information on the frequency range combination associated with the IDC problem, or the assistance information on the time domain associated with the IDC problem is for dual connectivity.

25. The first node of claim 24, wherein the at least one processor is further configured to:
transmit, to the terminal, a third message including at least one of information for the terminal to report assistance information about the IDC problem associated with a frequency range, or information for the terminal to report assistance information about the IDC problem associated with the time domain,
wherein the information for the terminal to report the assistance information about the IDC problem associated with the frequency range includes information on the frequency range considered when reporting the IDC problem, and
wherein the information on the frequency range includes information on a frequency and information on a bandwidth associated with the frequency.

26. The first node of claim 24, wherein the assistance information on the frequency range combination associated with the IDC problem includes at least one of information on a frequency range affected by the IDC problem, inference direction information, or information on a system influenced by IDC problem.

27. The first node of claim 24, wherein the assistance information on the time domain associated with the IDC problem includes at least one of information on a cycle length, information on a start offset, or information on an active duration.

28. A second node in a communication system, the second node comprising:
a transceiver; and
at least one processor coupled with the transceiver and configured to:
receive, from a first node, a second message including at least one of assistance information on a frequency range combination associated with an in-device coexistence (IDC) problem, or assistance information on a time domain associated with the IDC problem, when the IDC problem is not processed by the first node,
wherein a first message including at least one of the assistance information on the frequency range combination associated with the IDC problem, or the assistance information on the time domain associated with the IDC problem is transmitted from a terminal to the first node, and
wherein the assistance information on the frequency range combination associated with the IDC problem, or the assistance information on the time domain associated with the IDC problem is for dual connectivity.

29. The second node of claim 28, wherein a third message including at least one of information for the terminal to report assistance information about the IDC problem associated with a frequency range, or information for the terminal to report assistance information about the IDC problem associated with the time domain is transmitted from the first node to the terminal,
wherein the information for the terminal to report the assistance information about the IDC problem associated with the frequency range includes information on the frequency range considered when reporting the IDC problem, and
wherein the information on the frequency range includes information on a frequency and information on a bandwidth associated with the frequency.

30. The second node of claim 28, wherein the assistance information on the frequency range combination associated with the IDC problem includes at least one of information on a frequency range affected by the IDC problem, inference direction information, or information on a system influenced by IDC problem.

31. The second node of claim 28, wherein the assistance information on the time domain associated with the IDC problem includes at least one of information on a cycle length, information on a start offset, or information on an active duration.
